(19) United States
(12) Patent Application Publication
(10) Pub. No.: US 2015/0256827 A1
(43) Pub. Date: Sep. 10, 2015

(54) VIDEO ENCODING DEVICE, VIDEO DECODING DEVICE, VIDEO ENCODING METHOD, AND VIDEO DECODING METHOD

(71) Applicant: MITSUBISHI ELECTRIC CORPORATION, Tokyo (JP)

(72) Inventors: Akira Minezawa, Tokyo (JP); Kazuo Sugimoto, Tokyo (JP); Shunichi Sekiguchi, Tokyo (JP)

(73) Assignee: MITSUBISHI ELECTRIC CORPORATION, TOKYO (JP)

(21) Appl. No.: 14/432,175

(22) PCT Filed: Sep. 6, 2013
(86) PCT No.: PCT/JP2013/005284

§ 371 Date: Mar. 27, 2015

(30) Foreign Application Priority Data
Sep. 28, 2012 (JP) 2012-215379

(51) Int. Cl. H04N 19/11; H04N 19/117; H04N 19/139; H04N 19/176

(52) U.S. Cl. CPC H04N 19/11; H04N 19/176; H04N 19/117; H04N 19/139

(57) ABSTRACT

There is a problem that when performing field encoding on an interlaced signal, the space resolution in a vertical direction is reduced to one half and the correlation between pixels degrades, and, as a result, the prediction efficiency of intra prediction and the coding efficiency of orthogonal transformation coefficients degrade. In accordance with the present invention, there is provided an intra predictor that when a flag based on information showing whether or not field encoding is performed is valid, in case of a horizontal prediction, does not perform a filtering process on a prediction block at a time of performing an intra prediction process according to the horizontal prediction, but in case of a mean value prediction, performs a filtering process only on the left edge of the prediction block at a time of performing an intra prediction process according to the mean value prediction.

### FIELD OF THE INVENTION

The present invention relates to a video encoding device for and a moving image encoding method of encoding a moving image with a high degree of efficiency, and a video decoding device for and a moving image decoding method of decoding an encoded moving image with a high degree of efficiency.

### BACKGROUND OF THE INVENTION

Conventionally, in accordance with an international standard video encoding method, such as MPEG or ITU-T H.26x, after an inputted video frame is partitioned into macroblocks each of which consists of blocks of 16×16 pixels and a motion-compensated prediction is performed on each of the macroblocks, information compression is performed on the inputted video frame by performing orthogonal transformation and quantization on a prediction difference signal on a per block basis.

FIG. 23 is a structural diagram showing a video encoding device compliant with MPEG-4 AVC/H.264, which is disclosed by nonpatent reference 1.

In this video encoding device, when receiving an image signal which is a target to be encoded, a block partitioning unit 101 partitions the image signal into macroblocks and outputs an image signal of each of the macroblocks to a prediction unit 102 as a partitioned image signal.

When receiving the partitioned image signal from the block partitioning unit 101, the prediction unit 102 performs an intra-frame or inter-frame prediction on the image signal of each color component in each of the macroblocks to determine a prediction difference signal

Particularly when performing a motion-compensated prediction between frames, a search for a motion vector is performed on each macroblock itself or each of subblocks into which each macroblock is further partitioned finely.

Then, a motion-compensated prediction image is generated by performing a motion-compensated prediction on a reference image signal stored in a memory 107 by using the motion vector, and a prediction difference signal is calculated by determining the difference between a prediction signal showing the motion-compensated prediction image and the partitioned image signal.

On the other hand, according to the nonpatent reference 1, when an intra-frame prediction is performed, one prediction mode can be selected on a per block basis from a plurality of prediction modes as an intra prediction mode for brightness.

FIG. 24 is an explanatory drawing showing an intra prediction mode in the case in which the block size for brightness is 4×4 pixels.

In FIG. 24, each white circle in the block shows a pixel to be encoded, and each black circle shows an already-encoded pixel which is a pixel used for prediction. In the case in which the block size for brightness is 4×4 pixels, nine intra prediction modes including from mode 0 to mode 8 are defined.

In FIG. 24, the mode 2 is a mode in which a mean value (DC) prediction is performed, and in which each pixel within a block is predicted by using the mean value of the pixels adjacent to the upper and left edges of the block.

The modes other than the mode 2 are modes in which a directional prediction is performed. The mode 0 is a vertical prediction in which a prediction image is generated by repeatedly copying the pixels adjacent to the upper edge of the block in a vertical direction. For example, the mode 0 is selected in the case of a vertical stripe pattern.

The mode 1 is a horizontal prediction in which a prediction image is generated by repeatedly copying the pixels adjacent to the left edge of the block in a horizontal direction. For example, the mode 1 is selected in the case of a horizontal stripe pattern.

In each of the modes 3 to 8, by using already-encoded pixels located above the block or to the left of the block, interpolation pixels are generated in a predetermined direction (direction shown by arrows) and a prediction image is generated.

In this case, the block size for brightness to which an intra prediction is applied can be selected from 4×4 pixels, 8×8 pixels, and 16×16 pixels, and, in the case of 8×8 pixels, nine intra prediction modes are defined, like in the case of 4×4 pixels. However, as pixels used for prediction, already-encoded pixels themselves are not used, and, instead, these pixels on which a filtering process is performed are used.

In contrast, in the case of 16×16 pixels, in addition to the intra prediction modes associated with the mean value prediction, the vertical prediction, and the horizontal prediction, four intra prediction modes called Plane prediction are defined.

Each of the intra prediction modes associated with the Plane prediction is a mode in which pixels generated by performing interpolation in a diagonal direction on already-encoded pixels adjacent to the upper and left edges of the block are provided as predicted values.

Further, a predicting unit 102 outputs parameters for prediction signal generation which the predicting unit determines when acquiring the prediction signal to a variable length encoding unit 108.

For example, the parameters for prediction signal generation include pieces of information, such as an intra prediction mode indicating how a spatial prediction is performed within each frame, and a motion vector indicating an amount of motion between frames.

When receiving the prediction difference signal from the predicting unit 102, a compressing unit 103 removes a signal correlation by performing a DCT (discrete cosine transform) process on the prediction difference signal and then quantizes this prediction difference signal to acquire compressed data.

When receiving the compressed data from the compressing unit 103, a local decoding unit 104 calculates a prediction difference signal corresponding to the prediction difference signal outputted from the predicting unit 102 by inverse-quantizing the compressed data and then performing an inverse DCT process on the compressed data.

When receiving the prediction difference signal from the local decoding unit 104, an adding unit 105 adds the prediction difference signal and the prediction signal outputted from the predicting unit 102 to generate a local decoded image.

A loop filter 106 eliminates a block distortion piggybacked onto a local decoded image signal showing the local decoded image generated by the adding unit 105, and stores the local decoded image signal from which the distortion is eliminated in a memory 107 as a reference image signal.

When receiving the compressed data from the compressing unit 103, a variable length encoding unit 108 entropy-encodes the compressed data and outputs a bitstream which is the encoded result.

When outputting the bitstream, the variable length encoding unit 108 multiplexes the parameters for prediction signal generation outputted from the predicting unit 102 into the bitstream and outputs this bitstream.

In general, as the format which a video signal which is the target to be encoded has, there are a progressive signal, as shown in FIG. 25, in which all of each frame consists of a signal of the same time, and an interlaced signal, as shown in FIG. 26, in which each frame consists of two signals (fields) of different times. In the video encoding device disclosed by nonpatent reference 1, in order to encode an interlaced signal efficiently, various encoding tools, such as a function of adaptively switching between encoding of the interlaced signal as a frame and encoding of the interlaced signal as a field on a per picture basis and on a per macroblock basis is incorporated.

### RELATED ART DOCUMENT

### Nonpatent Reference

Nonpatent reference 1: MPEG-4 AVC (ISO/IEC 14496-10)/H. ITU-T 264 standards
Nonpatent reference 2: “High efficiency video coding (HEVC) text specification draft 8”, JCT-VC Document JCTVC-J1003, July 2012, Stockholm, SE.

### SUMMARY OF THE INVENTION

### Problems to be Solved by the Invention

On the other hand, in the method disclosed by the nonpatent reference 2, no special encoding tool for an improvement of the coding efficiency of the interlaced signal is prepared. According to the method disclosed by the nonpatent reference 2, at the time of an intra prediction, a filtering process for improving the continuity at a block boundary is performed on a prediction image in a specific intra prediction mode, as shown in FIG. 27. However, when encoding is performed on a per field basis, because spatial correlation in a vertical direction degrades, the effect of the filtering process on the upper edge of each block may degrade greatly.

Further, in the method disclosed by the nonpatent reference 2, as a method of encoding orthogonal transformation coefficients, each orthogonal transformation block is further partitioned into blocks (coding sub-blocks) of 4×4 pixels each of which is called a Coefficient Group (CG), and a process of encoding coefficients is performed on a per CG basis. The order (scanning order) of encoding the coefficients in each 16×16 pixel orthogonal transformation block is shown in FIG. 28. A process of encoding 16 CGs of 4×4 pixels is performed in order from the CG at the lower right corner in this way, and the 16 coefficients in each CG are further encoded in order from the coefficient at the lower right corner. Concretely, flag information showing whether a significant (non-zero) coefficient exists in the 16 coefficients in each CG is encoded first, whether or not each coefficient in the CG is a significant (non-zero) coefficient is then encoded in the above-mentioned order only when a significant (non-zero) coefficient exists in the CG, and, for each significant (non-zero) coefficient, information about its coefficient value is finally encoded in order. This process is performed in the above-mentioned order on a per CG basis. At that time, it is preferable to configure the scanning order in such a way that significant (non-zero) coefficients appear as consecutively as possible, thereby being able to improve the coding efficiency according to the entropy encoding. Because the appearance distribution of significant (non-zero) coefficients differs between a progressive video and an interlace video, the encoding cannot be performed efficiently by simply following the scanning order of FIG. 28.

Because the video encoding device disclose by the nonpatent reference 2 is constructed as above, there arises a problem that when performing field encoding on an interlaced signal, the space resolution in a vertical direction is reduced to one half and the correlation between pixels degrades, and, as a result, the prediction efficiency of intra prediction and the coding efficiency of orthogonal transformation coefficients degrade.

The present invention is made in order to solve the above-mentioned problem, and it is therefore an object of the present invention to provide a video encoding device, a video decoding device, a video encoding method, and a video decoding method capable of, even when performing field encoding of an interlaced signal, improving the coding efficiency at the time of performing the field encoding of the interlaced signal.

### Means for Solving the Problem

In accordance with the present invention, there is provided a video encoding device including an intra predictor that, when an intra coding mode is selected as a coding mode corresponding to a coding block, performs an intra-frame prediction process corresponding to an intra prediction parameter on each prediction block which is a unit for prediction process, which is shown by the above-mentioned intra coding mode, at a time of performing a prediction process on the coding block, the intra prediction parameter being used for the above-mentioned prediction block, to generate a prediction image, in which when a flag based on information showing whether or not field encoding is performed is valid, in case of a horizontal prediction, the above-mentioned intra predictor does not perform a filtering process on the prediction block at a time of performing an intra prediction process according to the horizontal prediction, but in case of a mean value prediction, performs a filtering process only on the left edge of the prediction block at a time of performing an intra prediction process according to the mean value prediction.

### Advantages of the Invention

In accordance with the present invention, because the intra predictor is configured in such a way as to, when the flag based on the information showing whether or not the field encoding is performed is valid, in case of a horizontal prediction, not perform a filtering process on a prediction block at the time of performing an intra prediction process according to the horizontal prediction, but in case of a mean value prediction, perform a filtering process only on the left edge of the prediction block at the time of performing an intra prediction process according to the mean value prediction, there is provided an advantage of being able to implement an efficient prediction process and an encoding process according to the characteristics of the field signal, and improve the coding efficiency.

### BRIEF DESCRIPTION OF THE FIGURES

FIG. 1 is a block diagram showing a video encoding device in accordance with Embodiment 1 of the present invention;

FIG. 2 is a flow chart showing processing (video encoding method) performed by the video encoding device in accordance with Embodiment 1 of the present invention;

FIG. 3 is a block diagram showing a video decoding device in accordance with Embodiment 1 of the present invention;

FIG. 4 is a flow chart showing processing (video decoding method) performed by the video decoding device in accordance with Embodiment 1 of the present invention;

FIG. 5 is an explanatory drawing showing an example in which each largest coding block is partitioned hierarchically into a plurality of coding blocks;

FIG. 6(a) is an explanatory drawing showing the distribution of coding blocks and prediction blocks after partitioning, and FIG. 6(b) is an explanatory drawing showing a state in which a coding mode m(Bⁿ) is assigned to each of the blocks through hierarchical layer partitioning;

FIG. 7 is an explanatory drawing showing an example of an intra prediction parameter (intra prediction mode) which can be selected for each prediction block Pᵢⁿ in a coding block Bⁿ;

FIG. 8 is an explanatory drawing showing an example of pixels which are used when generating a predicted value of each pixel in a prediction block Pᵢⁿ in the case of lᵢⁿ=m₁ⁿ=4;

FIG. 9 is an explanatory drawing showing relative coordinates of each pixel in the prediction block Pᵢn which are determined with the pixel at the upper left corner of the prediction block Pᵢⁿ being defined as the point of origin;

FIG. 10 is an explanatory drawing showing an example of a quantization matrix;

FIG. 11 is an explanatory drawing showing an example of a structure of using a plurality of loop filtering processes in a loop filter unit of the video encoding device in accordance with Embodiment 1 of the present invention;

FIG. 12 is an explanatory drawing showing an example of the structure of using a plurality of loop filtering processes in the loop filter unit of the video encoding device in accordance with Embodiment 1 of the present invention;

FIG. 13 is an explanatory drawing showing an example of an encoded bitstream;

FIG. 14 is an explanatory drawing showing indexes indicating class classifying methods for use in the pixel adaptive offset process;

FIG. 15 is an explanatory drawing showing an example of the distribution of transform coefficients in orthogonal transformation on a size of 16×16 pixels;

FIG. 16 is an explanatory drawing showing an example of the distribution of transform coefficients in orthogonal transformation on a size of 16×16 pixels in a field signal;

FIG. 17 is an explanatory drawing showing the encoding order of transform coefficients in orthogonal transformation on a size of 16×16 pixels in the field signal;

FIG. 18 is an explanatory drawing showing the encoding order of transform coefficients in orthogonal transformation on a size of 16×16 pixels in the field signal;

FIG. 19 is an explanatory drawing showing the encoding order of transform coefficients in orthogonal transformation on a size of 16×16 pixels in the field signal;

FIG. 20 is an explanatory drawing showing regions for which switching of filters is performed in a filtering process at the time of a mean value prediction;

FIG. 21 is an explanatory drawing showing the arrangement of reference pixels in the filtering process at the time of the mean value prediction;

FIG. 22 is an explanatory drawing showing a filtering process on an intra prediction image at the time of field encoding;

FIG. 23 is a block diagram showing a video encoding device disclosed in nonpatent reference 1;

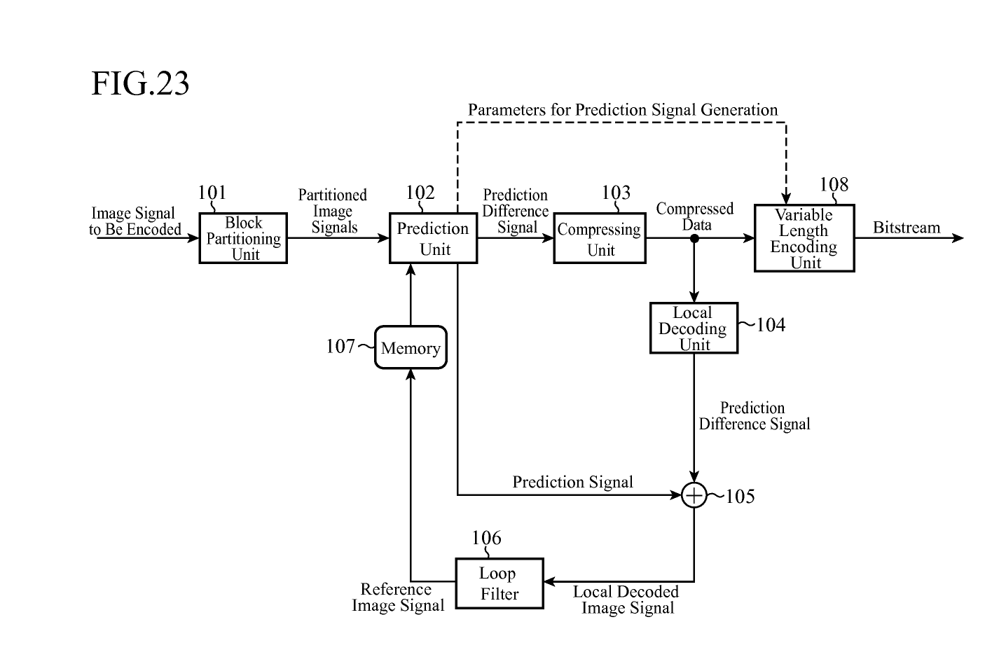

FIG. 24 is an explanatory drawing showing intra prediction modes in a case in which the block size for brightness is 4×4 pixels;

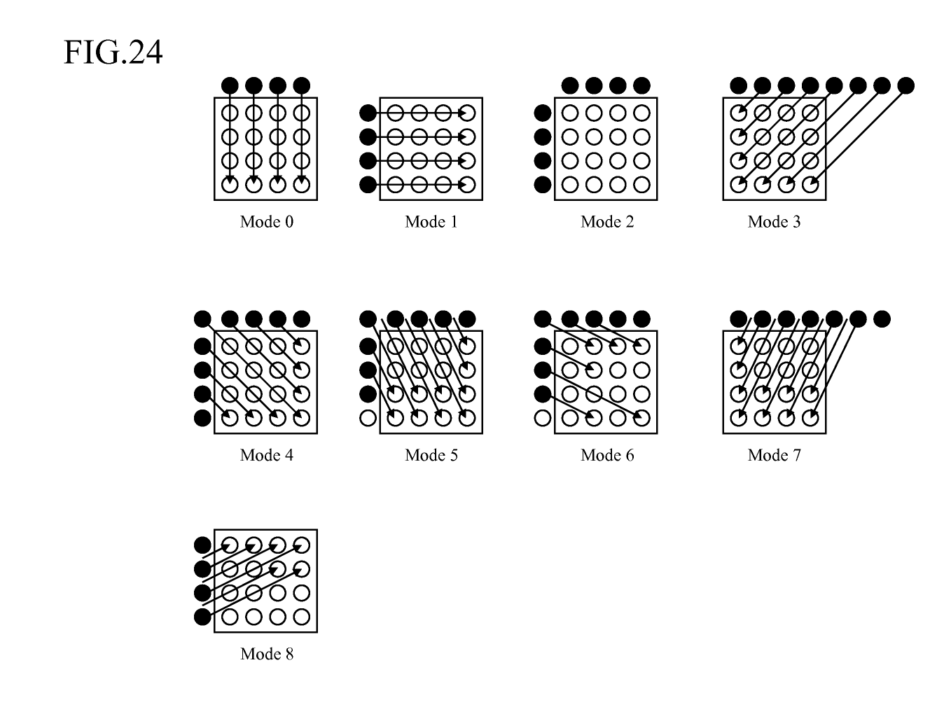

FIG. 25 is an explanatory drawing showing a progressive video signal;

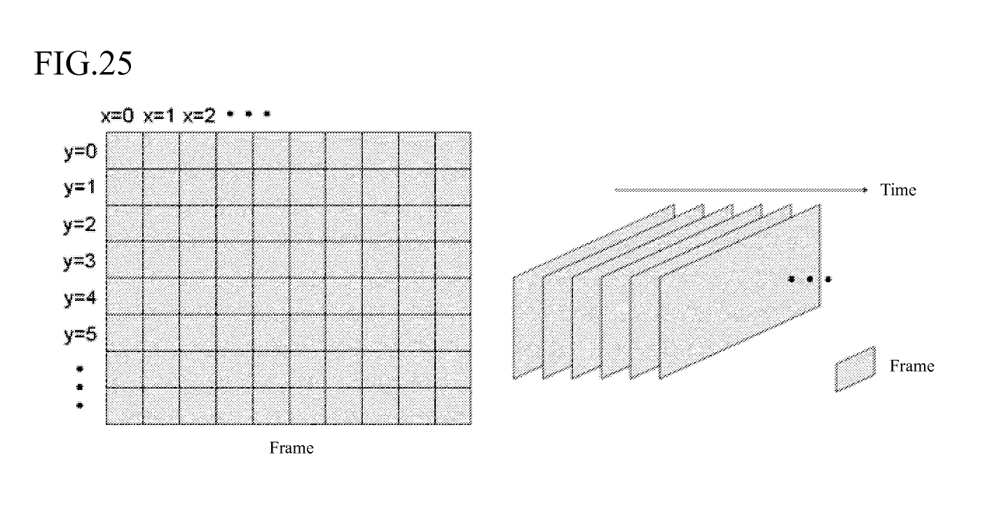

FIG. 26 is an explanatory drawing showing an interlaced video signal;

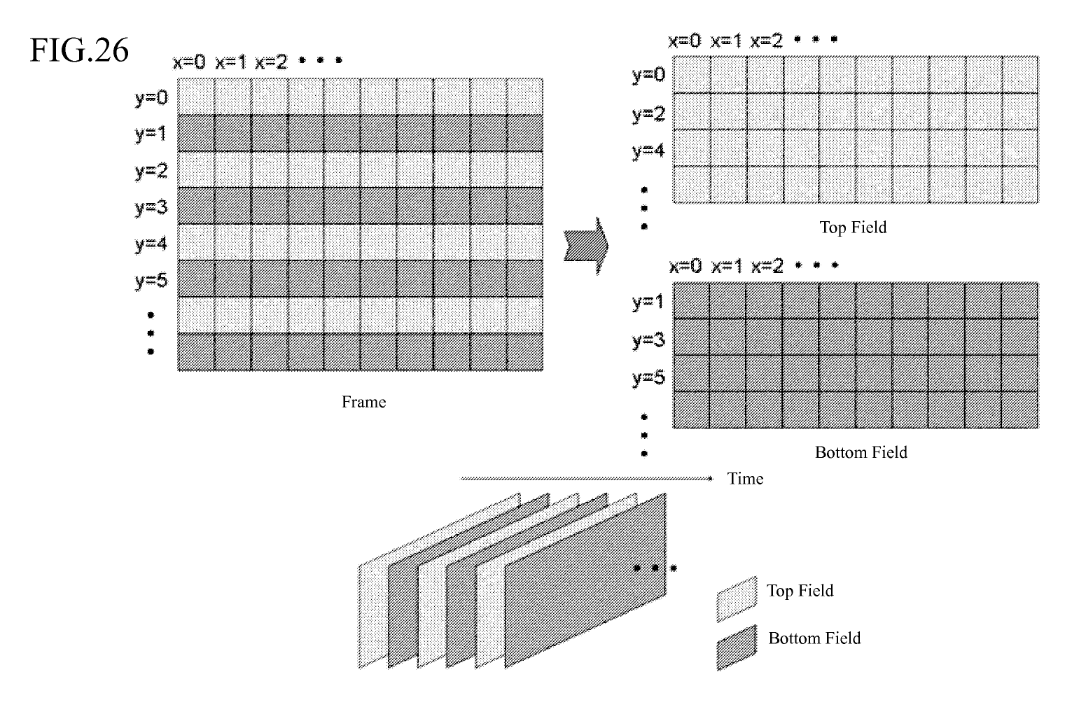

FIG. 27 is an explanatory drawing showing a filtering process in an intra prediction; and

FIG. 28 is an explanatory drawing showing the encoding order of transform coefficients in orthogonal transformation on a size of 16×16 pixels.

### EMBODIMENTS OF THE INVENTION

### Embodiment 1

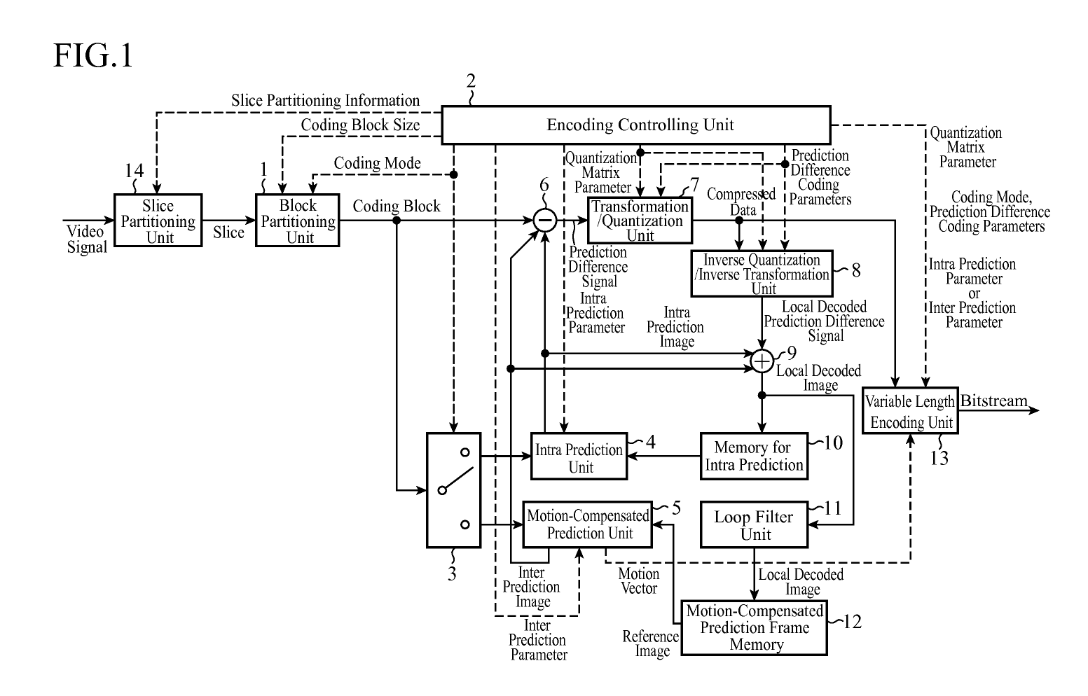

FIG. 1 is a block diagram showing a video encoding device in accordance with Embodiment 1 of the present invention.

Referring to FIG. 1, a slice partitioning unit 14 performs a process of, when receiving a video signal as an inputted image, partitioning the inputted image into one or more part images, which are referred to as “slices”, according to slice partitioning information determined by an encoding controlling unit 2. Each slice partitioned can be partitioned into coding blocks which will be mentioned below. The slice partitioning unit 14 constructs a slice partitioner.

A block partitioning unit 1 performs a process of, every time when receiving a slice partitioned by the slice partitioning unit 14, partitioning the slice into largest coding blocks each of which is a coding block having a largest size determined by the encoding controlling unit 2, and further partitioning each of the largest coding blocks into coding blocks hierarchically until the number of hierarchical layers reaches an upper limit determined by the encoding controlling unit 2.

More specifically, the block partitioning unit 1 performs a process of partitioning each slice into coding blocks according to partitioning determined by the encoding controlling unit 2, and outputting each of the coding blocks. Each of the coding blocks is further partitioned into one or more prediction blocks each of which is a unit for prediction process.

The block partitioning unit 1 constructs a block partitioner.

The encoding controlling unit 2 performs a process of determining the largest size of each of the coding blocks which is a unit to be processed at the time when an encoding process is performed, and also determining the size of each of the coding blocks by determining the upper limit on the number of hierarchical layers at the time when each of the coding blocks having the largest size is hierarchically partitioned.

The encoding controlling unit 2 also performs a process of selecting a coding mode which is applied to each coding block outputted from the block partitioning unit 1 from one or more selectable coding modes (one or more intra coding modes in which the size or the like of each prediction block representing a unit for prediction process differs and one or more inter coding modes in which the size or the like of each prediction block differs). As an example of the selecting method, there is a method of selecting a coding mode which provides the highest degree of coding efficiency for each coding block outputted from the block partitioning unit 1 from the one or more selectable coding modes.

The encoding controlling unit 2 also performs a process of, when the coding mode having the highest degree of coding efficiency is an intra coding mode, determining an intra prediction parameter which is used when performing an intra prediction process on the coding block in the intra coding mode for each prediction block which is a unit for prediction process shown by the above-mentioned intra coding mode, and, when the coding mode having the highest degree of coding efficiency is an inter coding mode, determining an inter prediction parameter which is used when performing an inter prediction process on the coding block in the inter coding mode for each prediction block which is a unit for prediction process shown by the above-mentioned inter coding mode.

The encoding controlling unit 2 further performs a process of determining prediction difference coding parameters which the encoding controlling unit provides for a transformation/quantization unit 7 and an inverse quantization/inverse transformation unit 8. Orthogonal transformation block partitioning information showing information about partitioning into orthogonal transformation blocks which are units for orthogonal transformation process in the coding block, a quantization parameter defining a quantization stepsize at the time of performing quantization on transform coefficients, and so on are included in the prediction difference coding parameters.

The encoding controlling unit 2 constructs an encoding controller.

A select switch 3 performs a process of, when the coding mode determined by the encoding controlling unit 2 is an intra coding mode, outputting the coding block outputted from the block partitioning unit 1 to an intra prediction unit 4, and, when the coding mode determined by the encoding controlling unit 2 is an inter coding mode, outputting the coding block outputted from the block partitioning unit 1 to a motion-compensated prediction unit 5.

When an intra coding mode is selected by the encoding controlling unit 2 as the coding mode corresponding to the coding block outputted from the select switch 3, the intra prediction unit 4 performs an intra prediction process (intra-frame prediction process) on each prediction block, which is a unit for prediction process at the time of performing a prediction process on the coding block, by using the intra prediction parameter determined by the encoding controlling unit 2 while referring to a local decoded image stored in a memory 10 for intra prediction, and performs a process of generating an intra prediction image.

When an inter coding mode is selected by the encoding controlling unit 2 as the coding mode corresponding to the coding block outputted from the select switch 3, the motion-compensated prediction unit 5 compares the coding block with one or more frames of local decoded image stored in a motion-compensated prediction frame memory 12 for each prediction block, which is a unit for prediction process, to search for a motion vector, performs an inter prediction process (motion-compensated prediction process) for the coding block on each prediction block by using the motion vector and the inter prediction parameter, such as a frame number to be referred to, which is determined by the encoding controlling unit 2, and performs a process of generating an inter prediction image.

A predictor is comprised of the intra prediction unit 4, the memory 10 for intra prediction, the motion-compensated prediction unit 5, and the motion-compensated prediction frame memory 12.

A subtracting unit 6 performs a process of subtracting the intra prediction image generated by the intra prediction unit 4 or the inter prediction image generated by the motion-compensated prediction unit 5 from the coding block outputted from the block partitioning unit 1, and outputting a prediction difference signal showing a difference image which is the result of the subtraction to the transformation/quantization unit 7. The subtracting unit 6 constructs a difference image generator.

The transformation/quantization unit 7 refers to the orthogonal transformation block partitioning information included in the prediction difference coding parameters determined by the encoding controlling unit 2 and performs an orthogonal transformation process (e.g., an orthogonal transformation process, such as a DCT (discrete cosine transform), a DST (discrete sine transform), or a KL transform in which bases are designed for a specific learning sequence in advance) for the prediction difference signal outputted from the subtracting unit 6 on each orthogonal transformation block to calculate transform coefficients, and also refers to the quantization parameter included in the prediction difference coding parameters and performs a process of quantizing the transform coefficients of each orthogonal transformation block and outputting compressed data which are the transform coefficients quantized thereby to the inverse quantization/inverse transformation unit 8 and a variable length encoding unit 13.

The transformation/quantization unit 7 constructs an image compressor.

When quantizing the transform coefficients, the transformation/quantization unit 7 can perform the process of quantizing the transform coefficients by using a quantization matrix for scaling the quantization stepsize calculated from the above-mentioned quantization parameter for each of the transform coefficients.

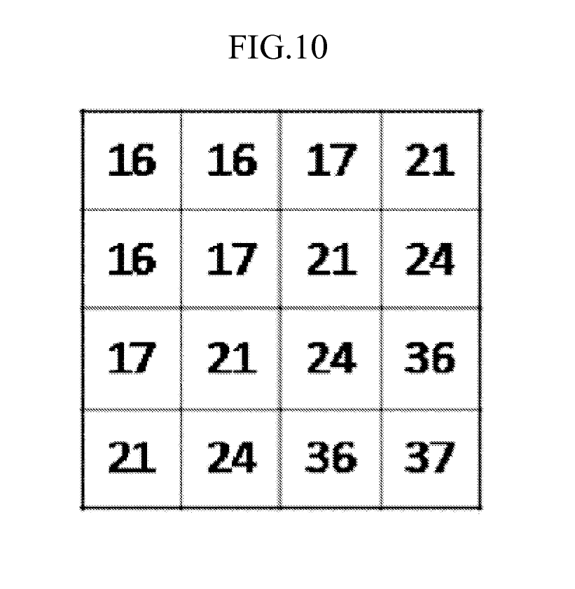

FIG. 10 is an explanatory drawing showing an example of the quantization matrix of a 4×4 DCT.

Numerals shown in the figure express scaling values for the quantization stepsizes of the transform coefficients.

For example, in order to suppress the coding bit rate, by performing the scaling in such a way that a transform coefficient in a higher frequency band has a larger quantization stepsize, as shown in FIG. 10, while transform coefficients in a high frequency band which occur in a complicated image area or the like are reduced, thereby suppressing the code amount, the encoding can be performed without reducing information about coefficients in a low frequency band which exert a great influence upon the subjective quality.

Thus, when it is desired that the quantization stepsize for each transform coefficient is controlled, what is necessary is just to use a quantization matrix.

Further, as the quantization matrix, a matrix which is independent for each chrominance signal and for each coding mode (intra coding or inter coding) at each orthogonal transformation size can be used, and either selection of a quantization matrix from a quantization matrix which is prepared, as an initial value, in advance and in common between the video encoding device and the video decoding device and an already-encoded quantization matrix or use of a new quantization matrix can be selected.

Therefore, the transformation/quantization unit 7 sets flag information showing whether or not to use a new quantization matrix for each chrominance signal and for each coding mode at each orthogonal transformation size to a quantization matrix parameter to be encoded.

In addition, when a new quantization matrix is used, each of the scaling values in the quantization matrix as shown in FIG. 10 is set to the quantization matrix parameter to be encoded. In contrast, when a new quantization matrix is not used, an index specifying a matrix to be used from a quantization matrix which is prepared, as an initial value, in advance and in common between the video encoding device and the video decoding device and an already-encoded quantization matrix is set to the quantization matrix parameter to be encoded. However, when no already-encoded quantization matrix which can be referred to exists, only a quantization matrix prepared in advance and in common between the video encoding device and the video decoding device can be selected.

The inverse quantization/inverse transformation unit 8 refers to the quantization parameter and the orthogonal transformation block partitioning information included in the prediction difference coding parameters determined by the encoding controlling unit 2 and inverse-quantizes the compressed data about each orthogonal transformation block outputted from the transformation/quantization unit 7, and also performs an inverse orthogonal transformation process on the transform coefficients which are the compressed data inverse-quantized thereby and performs a process of calculating a local decoded prediction difference signal corresponding to the prediction difference signal outputted from the subtracting unit 6. When the transformation/quantization unit 7 performs the quantizing process by using the quantization matrix, the inverse quantization/inverse transformation unit refers to the quantization matrix and performs a corresponding inverse quantization process also at the time of performing the inverse quantization process.

An adding unit 9 performs a process of adding the local decoded prediction difference signal calculated by the inverse quantization/inverse transformation unit 8 and either the intra prediction image generated by the intra prediction unit 4 or the inter prediction image generated by the motion-compensated prediction unit 5, to calculate a local decoded image corresponding to the coding block outputted from the block partitioning unit 1.

A local decoded image generator is comprised of the inverse quantization/inverse transformation unit 8 and the adding unit 9.

The memory 10 for intra prediction is a recording medium that stores the local decoded image calculated by the adding unit 9.

A loop filter unit 11 performs a predetermined filtering process on the local decoded image calculated by the adding unit 9, and performs a process of outputting the local decoded image filtering-processed thereby.

Concretely, the loop filter unit performs a filtering (deblocking filtering) process of reducing a distortion occurring at a boundary between orthogonal transformation blocks and a distortion occurring at a boundary between prediction blocks, a process (pixel adaptive offset process) of adaptively adding an offset on a per pixel basis, an adaptive filtering process of performing a filtering process by adaptively switching among linear filters, such as Wiener filters, and so on.

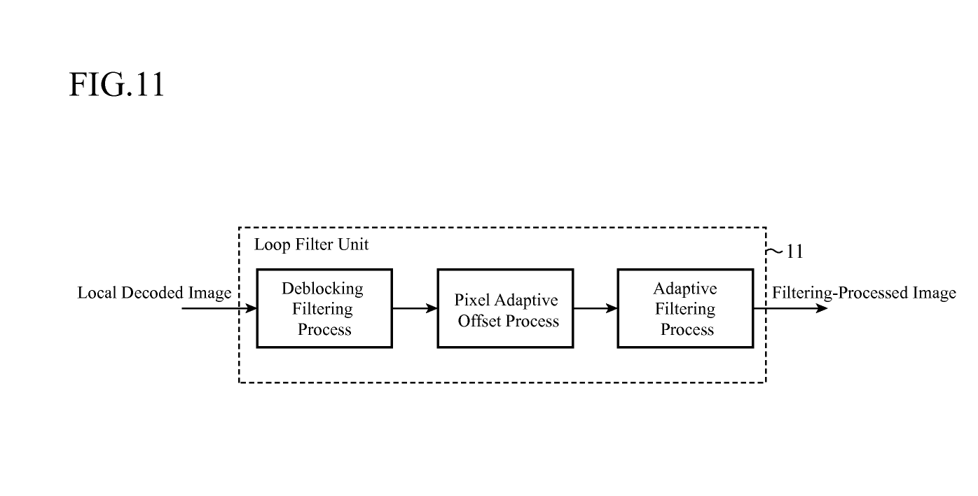

The loop filter unit 11 determines whether or not to perform the process for each of the above-mentioned processes including the deblocking filtering process, the pixel adaptive offset process, and the adaptive filtering process, and outputs an enable flag of each of the processes, as header information, to the variable length encoding unit 13. When using two or more of the above-mentioned filtering processes, the loop filter unit performs the two or more filtering processes in order. FIG. 11 shows an example of the structure of the loop filter unit 11 in the case of using a plurality of filtering processes.

In general, while the image quality is improved with increase in the number of types of filtering processes used, the processing load is increased conversely. More specifically, there is a trade-off between the image quality and the processing load. Further, an improvement effect of the image quality which is produced by each of the filtering processes differs depending upon the characteristics of the image which is the target for filtering process. Therefore, what is necessary is just to determine the filtering processes to be used according to the processing load acceptable in the video encoding device and the characteristics of the image which is the target for filtering process.

The loop filter unit 11 constructs a filter.

In the deblocking filtering process, various parameters used for the selection of the intensity of a filter to be applied to a block boundary can be changed from their initial values. When changing a parameter, the parameter is outputted to the variable length encoding unit 13 as header information.

In the pixel adaptive offset process, the image is partitioned into a plurality of blocks first, a case of not performing the offset process is defined as one class classifying method for each of the blocks, and one class classifying method is selected from among a plurality of class classifying methods which are prepared in advance.

Next, by using the selected class classifying method, each pixel included in the block is classified into one of classes, and an offset value for compensating for a coding distortion is calculated for each of the classes.

Finally, a process of adding the offset value to the brightness value of the local decoded image is performed, thereby improving the image quality of the local decoded image.

Therefore, in the pixel adaptive offset process, the block partitioning information, an index indicating the class classifying method selected for each block, and offset information specifying the offset value calculated for each class on a per block basis are outputted to the variable length encoding unit 13 as header information.

In the adaptive filtering process, a class classification is performed on the local decoded image by using a predetermined method, a filter for compensating for a distortion piggybacked on the image is designed for each area (local decoded image) belonging to each class, and a process of filtering the local decoded image is performed by using the filter.

The filter designed for each class is then outputted to the variable length encoding unit 13 as header information.

As the class classifying method, there are a simple method of partitioning the image into equal parts spatially and a method of performing a classification on a per block basis according to the local characteristics (a variance and so on) of the image.

Further, the number of classes used in the adaptive filtering process can be set in advance as a value common between the video encoding device and the video decoding device, or can be a parameter to be encoded.

While the improvement effect of the image quality in the latter case is enhanced as compared with that in the former case because the number of classes used in the latter case can be set freely, the code amount is increased by that required for the number of classes because the number of classes is encoded.

Because it is necessary for the loop filter unit 11 to refer to the video signal when performing the pixel adaptive offset process and the adaptive filtering process, it is necessary to modify the video encoding device shown in FIG. 1 in such a way that the video signal is inputted to the loop filter unit 11.

The motion-compensated prediction frame memory 12 is a recording medium that stores the local decoded image on which the filtering process is performed by the loop filter unit 11.

The variable length encoding unit 13 variable-length-encodes the compressed data outputted thereto from the transformation/quantization unit 7, the output signal of the encoding controlling unit 2 (the block partitioning information about the partitioning of each largest coding block, the coding mode, the prediction difference coding parameters, and the intra prediction parameter or the inter prediction parameter), and the motion vector outputted from the motion-compensated prediction unit 5 (when the coding mode is an inter coding mode), and generates encoded data.

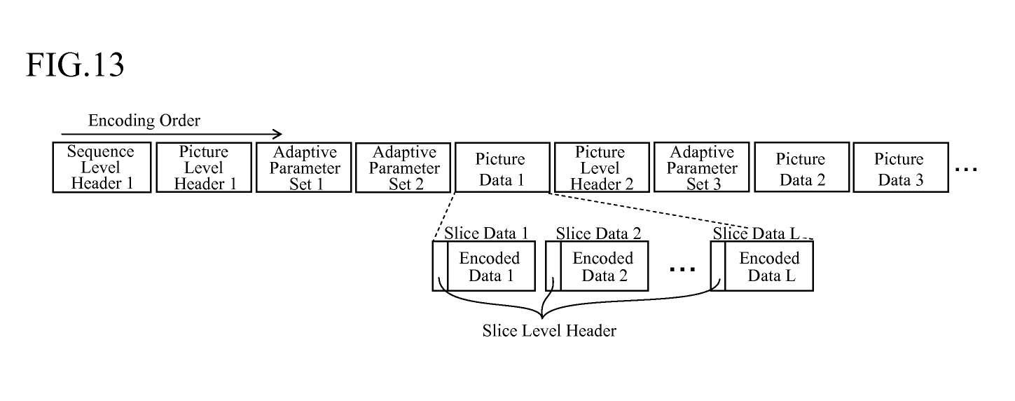

The variable length encoding unit 13 also encodes sequence level headers and picture level headers, as the header information of an encoded bitstream, as illustrated in FIG. 13, and generates an encoded bitstream as well as picture data.

The variable length encoding unit 13 constructs a variable length encoder.

Picture data consists of one or more slice data, and each slice data is a combination of a slice level header and encoded data as mentioned above in the slice currently being processed.

A sequence level header is generally a combination of pieces of header information which are common on a per sequence basis, the pieces of header information including the image size, the chrominance signal format, the bit depths of the signal values of the luminance signal and the color difference signals, and the enable flag information about each of the filtering processes (the adaptive filtering process, the pixel adaptive offset process, and the deblocking filtering process) which are performed on a per sequence basis by the loop filter unit 11, the enable flag information of the quantization matrix, a flag showing whether or not field encoding is performed, and so on.

A picture level header is a combination of pieces of header information which are set on a per picture basis, the pieces of header information including an index indicating a sequence level header to be referred to, the number of reference pictures at the time of motion compensation, and a probability table initialization flag for entropy encoding, the quantization matrix parameter, and so on.

A slice level header is a combination of parameters which are set on a per slice basis, the parameters including position information showing at which position of the picture the slice currently being processed exists, an index indicating which picture level header is to be referred to, the encoding type of the slice (all intra encoding, inter encoding, or the like), the flag information showing whether or not to perform each of the filtering processes in the loop filter unit 11 (the adaptive filtering process, the pixel adaptive offset process, and the deblocking filtering process), and so on.

In the example shown in FIG. 1, it is assumed that the block partitioning unit 1, the encoding controlling unit 2, the select switch 3, the intra prediction unit 4, the motion-compensated prediction unit 5, the subtracting unit 6, the transformation/quantization unit 7, the inverse quantization/inverse transformation unit 8, the adding unit 9, the memory 10 for intra prediction, the loop filter unit 11, the motion-compensated prediction frame memory 12, and the variable length encoding unit 13, which are the components of the video encoding device, consist of pieces of hardware for exclusive use (e.g., semiconductor integrated circuits in each of which a CPU is mounted, one chip microcomputers, or the like), respectively. As an alternative, in a case in which the video encoding device consists of a computer, a program in which the processes performed by the block partitioning unit 1, the encoding controlling unit 2, the select switch 3, the intra prediction unit 4, the motion-compensated prediction unit 5, the subtracting unit 6, the transformation/quantization unit 7, the inverse quantization/inverse transformation unit 8, the adding unit 9, the loop filter unit 11, and the variable length encoding unit 13 are described can be stored in a memory of the computer and the CPU of the computer can be made to execute the program stored in the memory.

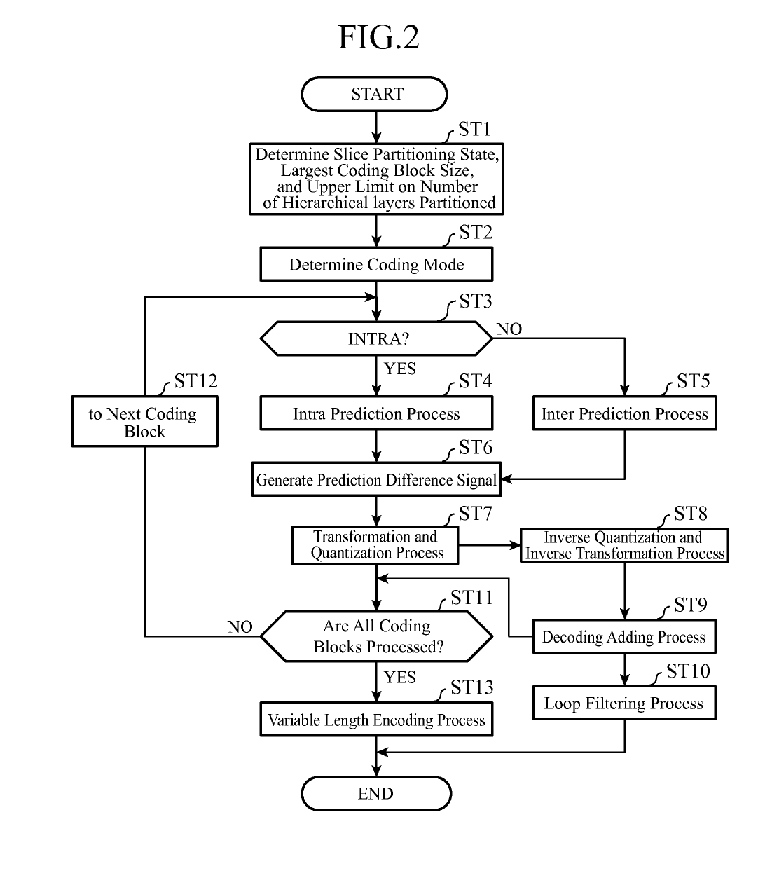

FIG. 2 is a flow chart showing the processing (video encoding method) performed by the video encoding device in accordance with Embodiment 1 of the present invention.

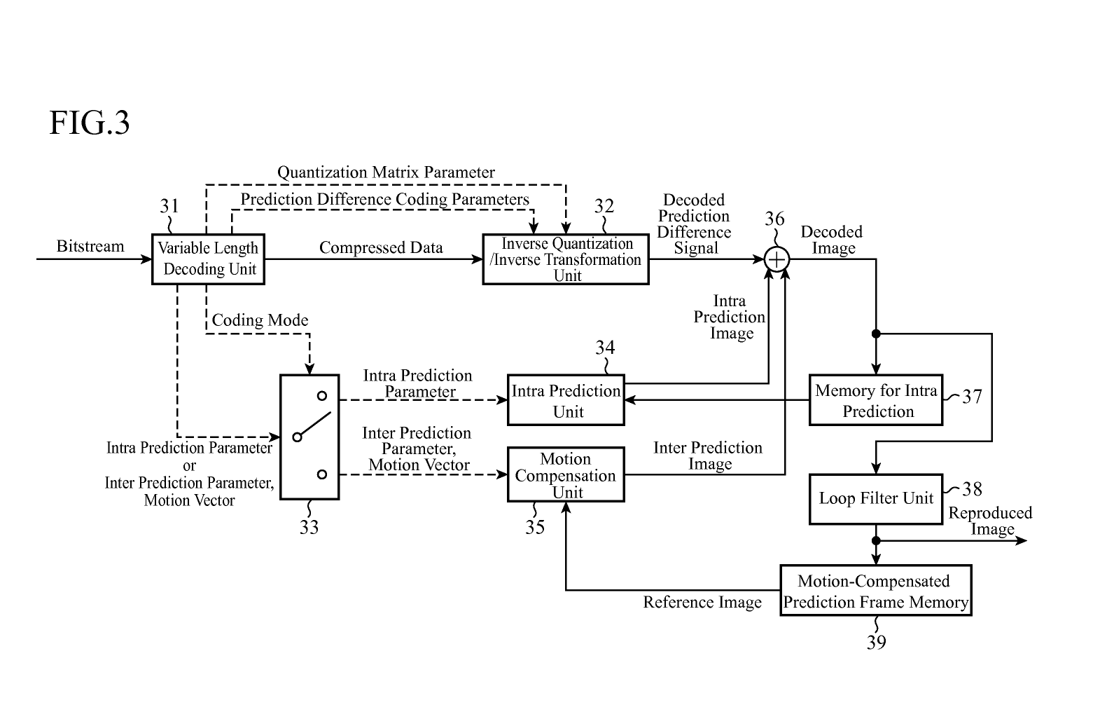

FIG. 3 is a block diagram showing the video decoding device in accordance with Embodiment 1 of the present invention.

Referring to FIG. 3, when receiving the encoded bitstream generated by the video encoding device shown in FIG. 1, a variable length decoding unit 31 decodes each of the pieces of header information, such as sequence level headers, picture level headers, and slice level headers, from the bitstream, and also variable-length-decodes the block partitioning information showing the partitioning state of each of coding blocks partitioned hierarchically from the bitstream.

At this time, the video decoding device specifies the quantization matrix from the quantization matrix parameter variable-length-decoded by the variable length decoding unit 31. Concretely, for each chrominance signal and for each coding mode at each orthogonal transformation size, when the quantization matrix parameter shows that either a quantization matrix which is prepared, as an initial value, in advance and in common between the video encoding device and the video decoding device, or an already-decoded quantization matrix is used (no new quantization matrix is used), the video decoding device refers to the index information specifying which quantization matrix in the above-mentioned matrices is used, to specify a quantization matrix, and, when the quantization matrix parameter shows that a new quantization matrix is used, specifies, as the quantization matrix to be used, the quantization matrix included in the quantization matrix parameter.

The variable length decoding unit 31 also performs a process of referring to each header information to specify the slice partitioning state, and also specifying each largest decoding block included in slice data about each slice (a block corresponding to each “largest coding block” in the video encoding device of FIG. 1), referring to the block partitioning information to specify each decoding block which is one of units into which each largest decoding block is hierarchically partitioned and on which the video decoding device performs a decoding process (a block corresponding to each “coding block” in the video encoding device of FIG. 1), and variable-length-decoding the compressed data, the coding mode, the intra prediction parameter (when the coding mode is an intra coding mode), the inter prediction parameter (when the coding mode is an inter coding mode), the prediction difference coding parameters, and the motion vector (when the coding mode is an inter coding mode), which are associated with each decoding block. The variable length decoding unit 31 constructs a variable length decoder.

An inverse quantization/inverse transformation unit 32 refers to the quantization parameter and the orthogonal transformation block partitioning information which are included in the prediction difference coding parameters variable-length-decoded by the variable length decoding unit and inverse-quantizes the compressed data variable-length-decoded by the variable length decoding unit 31 for each orthogonal transformation block, and also performs an inverse orthogonal transformation process on the transform coefficients which are the compressed data inverse-quantized thereby and performs a process of calculating a decoded prediction difference signal which is the same as the local decoded prediction difference signal outputted from the inverse quantization/inverse transformation unit 8 shown in FIG. 1. The inverse quantization/inverse transformation unit 32 constructs a difference image generator.

In this case, when each header information variable-length-decoded by the variable length decoding unit 31 shows that the inverse quantization process is performed for the slice currently being processed by using the quantization matrix, the inverse quantization/inverse transformation unit performs the inverse quantization process by using the quantization matrix.

Concretely, the inverse quantization/inverse transformation unit performs the inverse quantization process by using the quantization matrix specified from each header information.

A select switch 33 performs a process of, when the coding mode variable-length-decoded by the variable length decoding unit 31 is an intra coding mode, outputting the intra prediction parameter variable-length-decoded by the variable length decoding unit 31 to an intra prediction unit 34, and, when the coding mode variable-length-decoded by the variable length decoding unit 31 is an inter coding mode, outputting the inter prediction parameter and the motion vector which are variable-length-decoded by the variable length decoding unit 31 to a motion compensation unit 35.

When the coding mode associated with the decoding block specified from the block partitioning information variable-length-decoded by the variable length decoding unit 31 is an intra coding mode, the intra prediction unit 34 performs an intra prediction process (intra-frame prediction process) using the intra prediction parameter outputted from the select switch 33 on each prediction block, which is a unit for prediction process at the time of performing the prediction process on the decoding block, while referring to a decoded image stored in a memory 37 for intra prediction, and performs a process of generating an intra prediction image.

When the coding mode associated with the decoding block specified from the block partitioning information variable-length-decoded by the variable length decoding unit 31 is an inter coding mode, the motion compensation unit 35 performs an inter prediction process (motion-compensated prediction process) using the motion vector and the inter prediction parameter which are outputted from the select switch 33 on each prediction block, which is a unit for prediction process at the time of performing the prediction process on the above-mentioned decoding block, while referring to a decoded image stored in a motion-compensated prediction frame memory 39, and performs a process of generating an inter prediction image.

A predictor is comprised of the intra prediction unit 34, the memory 37 for intra prediction, the motion compensation unit 35, and the motion-compensated prediction frame memory 39.

An adding unit 36 performs a process of adding the decoded prediction difference signal calculated by the inverse quantization/inverse transformation unit 32 and the intra prediction image generated by the intra prediction unit 34 or the inter prediction image generated by the motion compensation unit 35, to calculate a decoded image which is the same as the local decoded image outputted from the adding unit 9 shown in FIG. 1. The adding unit 36 constructs a decoded image generator.

The memory 37 for intra prediction is a recording medium that stores the decoded image calculated by the adder 36 as a reference image used for intra prediction process.

The loop filter unit 38 performs a predetermined filtering process on the decoded image calculated by the adding unit 36 and performs a process of outputting the decoded image filtering-processed thereby.

Concretely, the loop filter unit performs a filtering (deblocking filtering) process of reducing a distortion occurring at a boundary between orthogonal transformation blocks and a distortion occurring at a boundary between prediction blocks, a process (pixel adaptive offset process) of adaptively adding an offset on a per pixel basis, an adaptive filtering process of performing a filtering process by adaptively switching among linear filters, such as Wiener filters, and so on.

However, for each of the above-mentioned filtering processes including the deblocking filtering process, the pixel adaptive offset process, and the adaptive filtering process, the loop filter unit 38 refers to each header information variable-length-decoded by the variable length decoding unit 31 to specify whether or not to perform the process in the slice currently being processed.

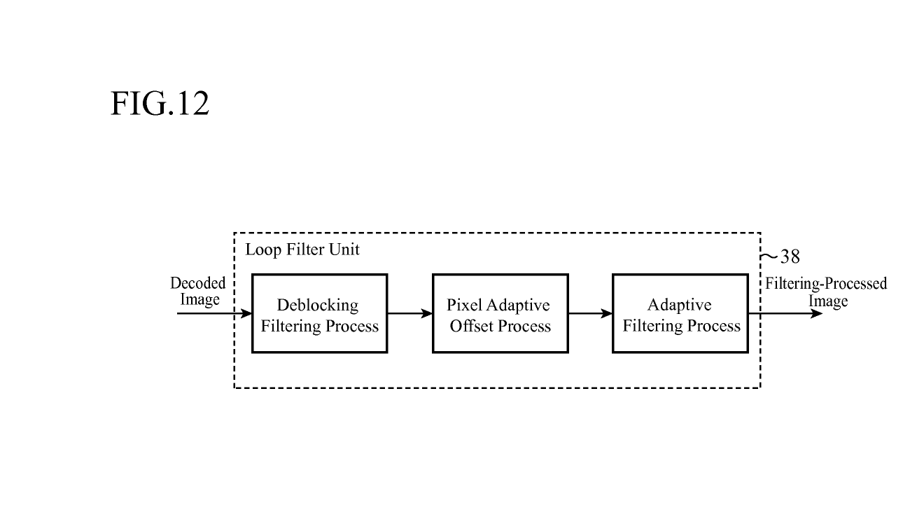

At this time, if the loop filter unit 11 of the video encoding device is configured as shown in FIG. 11 when performing two or more filtering processes, the loop filter unit 38 is configured as shown in FIG. 12.

The loop filter unit 38 constructs a filter.

In the deblocking filtering process, the loop filter unit refers to the header information variable-length-decoded by the variable length decoding unit 31, and, when there exists information for changing the various parameters used for the selection of the intensity of a filter applied to a block boundary from their initial values, performs the deblocking filtering process on the basis of the change information. When no change information exists, the loop filter unit performs the deblocking filtering process according to a predetermined method.

In the pixel adaptive offset process, the loop filter unit partitions the decoded image into blocks on the basis of the block partitioning information for the pixel adaptive offset process, which is variable-length-decoded by the variable length decoding unit 31, refers to the index variable-length-decoded by the variable length decoding unit 31 and indicating the class classifying method of each of the blocks on a per block basis, and, when the index does not indicate “does not perform the offset process”, performs a class classification on each pixel in each of the blocks according to the class classifying method indicated by the above-mentioned index.

As candidates for the class classifying method, the same candidates as those for the class classifying method of the pixel adaptive offset process performed by the loop filter unit 11 are prepared in advance.

The loop filter unit then refers to the offset information specifying the offset value calculated for each class on a per block basis, and performs a process of adding the offset to the brightness value of the decoded image.

However, in a case in which the pixel adaptive offset process performed by the loop filter unit 11 of the video encoding device is configured in such a way as to always partition the image into blocks each having a fixed size (e.g., largest coding blocks) without encoding the block partitioning information, select a class classifying method for each of the blocks, and perform the adaptive offset process for each class, the loop filter unit 38 also performs the pixel adaptive offset process on each block having the same fixed size as that in the loop filter unit 11.

In the adaptive filtering process, after performing a class classification according to the same method as that used by the video encoding device of FIG. 1, the loop filter unit performs the filtering process by using the filter for each class, which is variable-length-decoded by the variable length decoding unit 31, on the basis of information about the class classification.

The motion-compensated prediction frame memory 39 is a recording medium that stores the decoded image filtering-processed by the loop filter unit 38 as a reference image used for inter prediction process (motion-compensated prediction process).

In the example shown in FIG. 3, it is assumed that the variable length decoding unit 31, the inverse quantization/inverse transformation unit 32, the select switch 33, the intra prediction unit 34, the motion compensation unit 35, the adding unit 36, the memory 37 for intra prediction, the loop filter unit 38, and the motion-compensated prediction frame memory 39, which are the components of the video decoding device, consist of pieces of hardware for exclusive use (e.g., semiconductor integrated circuits in each of which a CPU is mounted, one chip microcomputers, or the like), respectively. As an alternative, in a case in which the video decoding device consists of a computer, a program in which the processes performed by the variable length decoding unit 31, the inverse quantization/inverse transformation unit 32, the select switch 33, the intra prediction unit 34, the motion compensation unit 35, the adding unit 36, and the loop filter unit 38 are described can be stored in a memory of the computer and the CPU of the computer can be made to execute the program stored in the memory.

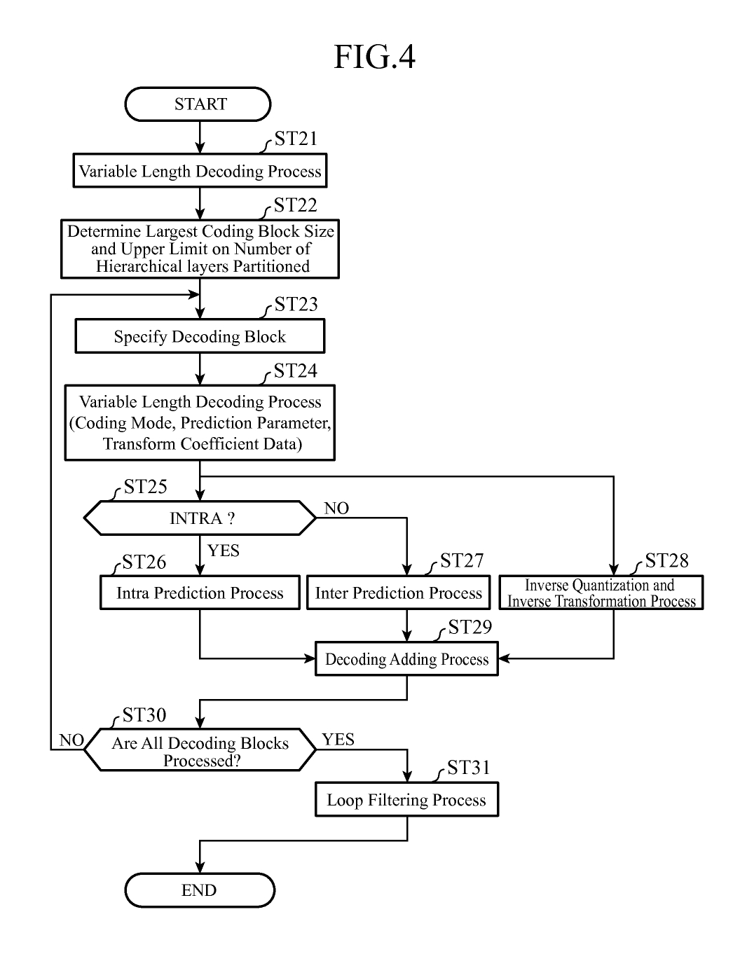

FIG. 4 is a flow chart showing the processing (video decoding method) performed by the video decoding device in accordance with Embodiment 1 of the present invention.

Next, operations will be explained.

In this Embodiment 1, a case in which the video encoding device receives each frame image of a video as an inputted image, performs an intra prediction from already-encoded neighborhood pixels or a motion-compensated prediction between adjacent frames, and performs a compression process with orthogonal transformation and quantization on an acquired prediction difference signal, and, after that, performs variable length encoding to generate an encoded bitstream, and the video decoding device decodes the encoded bitstream outputted from the video encoding device will be explained.

The video encoding device shown in FIG. 1 is characterized in that the video encoding device is adapted for local changes of a video signal in a space direction and in a time direction, partitions the video signal into blocks having various sizes, and performs intra-frame and inter-frame adaptive encoding.

In general, the video signal has a characteristic of its complexity locally changing in space and time. From the viewpoint of space, a certain video frame may have, for example, a pattern having a uniform signal characteristic in a relatively large image region, such as a sky image or a wall image, or a pattern in which a pattern having a complicated texture in a small image region, such as a person image or a picture including a fine texture, also coexists.

Also from the viewpoint of time, a sky image and a wall image have a small local change in a time direction in their patterns, while an image of a moving person or object has a larger temporal change because its outline has a movement of a rigid body and a movement of a non-rigid body with respect to time.

Although a process of generating a prediction difference signal having small signal power and small entropy by using a temporal and spatial prediction, thereby reducing the whole code amount, is performed in the encoding process, the code amount of parameters used for the prediction can be reduced as long as the parameters can be applied uniformly to as large an image signal region as possible.

On the other hand, because the amount of errors occurring in the prediction increases when the same prediction parameter is applied to a large image region in an image signal pattern having a large change in time and space, the code amount of the prediction difference signal increases.

Therefore, it is desirable that, for an image region having a large change in time and space, the size of a block subjected to the prediction process to which the same prediction parameter is applied is reduced, thereby increasing the data volume of the parameter which is used for the prediction and reducing the electric power and entropy of the prediction difference signal.

In this Embodiment 1, a structure of, in order to perform encoding which is adapted for such the typical characteristics of a video signal, starting the prediction process and so on from a predetermined largest block size first, hierarchically partitioning the region of the video signal into blocks, and adapting the prediction process and the process of encoding the prediction difference to each of the blocks partitioned is provided.

The format of a video signal to be processed by the video encoding device shown in FIG. 1 is assumed to be an arbitrary video signal in which each video frame consists of a series of digital samples (pixels) in two dimensions, horizontal and vertical, including a color video signal in arbitrary color space, such as a YUV signal which consists of a luminance signal and two color difference signals or an RGB signal outputted from a digital image sensor, a monochrome image signal, an infrared image signal, and so on.

The gradation of each pixel can be an 8-bit, 10-bit, or 12-bit one.

In the following explanation, for the sake of convenience, the video signal of the inputted image is assumed to be, unless otherwise specified, a YUV signal, and a case of handling signals having a 4:2:0 format in which the two color difference components U and V are subsampled with respect to the luminance component Y will be described.

As an alternative, the format of the color difference signals can be a format other than the 4:2:0 format of the YUV signal, and can be the 4:2:2 format or the 4:4:4 format of the YUV signal, or an RGB signal.

Further, a data unit to be processed which corresponds to each frame of the video signal is referred to as a “picture.”

A “picture” represents a frame signal when encoding is performed on a per frame basis, and represents a field signal when encoding is performed on a per field basis.

First, the processing performed by the video encoding device shown in FIG. 1 will be explained.

First, the encoding controlling unit 2 determines the slice partitioning state of a picture (current picture) which is the target to be encoded, and also determines the size of each largest coding block which is used for the encoding of the picture and the upper limit on the number of hierarchical layers at the time when each largest coding block is hierarchically partitioned into blocks (step ST1 of FIG. 2).

As a method of determining the size of each largest coding block, for example, there can be a method of determining the same size for all the pictures according to the resolution of the video signal of the inputted image, and a method of quantifying a variation in the complexity of a local movement of the video signal of the inputted image as a parameter and then determining a small size for a picture having a large and vigorous movement while determining a large size for a picture having a small movement.

As a method of determining the upper limit on the number of hierarchical layers partitioned, for example, there can be a method of determining the same number of hierarchical layers for all the pictures according to the resolution of the video signal of the inputted image, and a method of increasing the number of hierarchical layers to make it possible to detect a finer movement as the video signal of the inputted image has a larger and more vigorous movement, or decreasing the number of hierarchical layers as the video signal of the inputted image has a smaller movement.

The above-mentioned size of each largest coding block and the upper limit on the number of hierarchical layers at the time when each largest coding block is hierarchically partitioned into blocks can be encoded into the sequence level header or the like. Instead of encoding the size and the upper limit, the video decoding device can also perform the same determination process. In the former case, because while the code amount of the header information increases, the video decoding device does not have to perform the above-mentioned determination process, the processing load on the video decoding device can be reduced and the video encoding device can search for their optimal values and send these values to the video decoding device. In the latter case, on the contrary, because the video decoding device performs the above-mentioned determination process, while the processing load on the video decoding device increases, the code amount of the header information does not increase.

The encoding controlling unit 2 also selects a coding mode corresponding to each of the coding blocks into which the inputted image is hierarchically partitioned from one or more available coding modes (step ST2).

More specifically, the encoding controlling unit 2 hierarchically partitions each image region having the largest coding block size into coding blocks each having a coding block size until the number of hierarchical layers partitioned reaches the upper limit on the number of hierarchical layers partitioned which is determined in advance, and determines a coding mode for each of the coding blocks.

The coding mode is one of one or more intra coding modes (generically referred to as “INTRA”) and one or more inter coding modes (generically referred to as “INTER”), and the encoding controlling unit 2 selects a coding mode corresponding to each of the coding blocks from among all the coding modes available in the picture currently being processed or a subset of these coding modes.

Each of the coding blocks into which the inputted image is hierarchically partitioned by the block partitioning unit 1, which will be mentioned below, is further partitioned into one or more prediction blocks each of which is a unit on which a prediction process is to be performed, and the state of the partitioning into the one or more prediction blocks is also included as information in the coding mode. More specifically, the coding mode, which is an intra or inter coding mode, is an index identifying what type of partitioned prediction blocks are included.

Although a detailed explanation of a method of selecting a coding mode for use in the encoding controlling unit 2 will be omitted hereafter because the selecting method is a known technique, there is, for example, a method of performing an encoding process on each coding block by using arbitrary available coding modes to examine the coding efficiency, and selecting a coding mode having the highest degree of coding efficiency from among the plurality of available coding modes.

The encoding controlling unit 2 further determines a quantization parameter and an orthogonal transformation block partitioning state, which are used when a difference image is compressed, for each coding block, and also determines a prediction parameter (an intra prediction parameter or an inter prediction parameter) which is used when a prediction process is performed.

When each coding block is further partitioned into prediction blocks on each of which the prediction process is performed, the encoding controlling unit can select a prediction parameter (an intra prediction parameter or an inter prediction parameter) for each of the prediction blocks.

In addition, because when an intra prediction process is performed in a coding block whose coding mode is an intra coding mode, already-encoded pixels adjacent to each of the prediction blocks are used, which will be described in detail, it is necessary to perform encoding on a per prediction block basis, and therefore selectable transformation block sizes are limited to the size of the prediction block or less.

The encoding controlling unit 2 outputs prediction difference coding parameters including the quantization parameter and the transformation block size to the transformation/quantization unit 7, the inverse quantization/inverse transformation unit 8, and the variable length encoding unit 13.

The encoding controlling unit 2 also outputs the intra prediction parameter to the intra prediction unit 4 as needed.

The encoding controlling unit 2 further outputs the inter prediction parameter to the motion-compensated prediction unit 5 as needed.

When receiving the video signal as the inputted image, the slice partitioning unit 14 partitions the inputted image into one or more slices which are part images according to the slice partitioning information determined by the encoding controlling unit 2.

Every time when receiving each of the slices from the slice partitioning unit 14, the block partitioning unit 1 partitions the slice into coding blocks each having the largest coding block size determined by the encoding controlling unit 2, and further partitions each of the largest coding blocks, into which the inputted image is partitioned, into coding blocks hierarchically, these coding blocks being determined by the encoding controlling unit 2, and outputs each of the coding blocks.

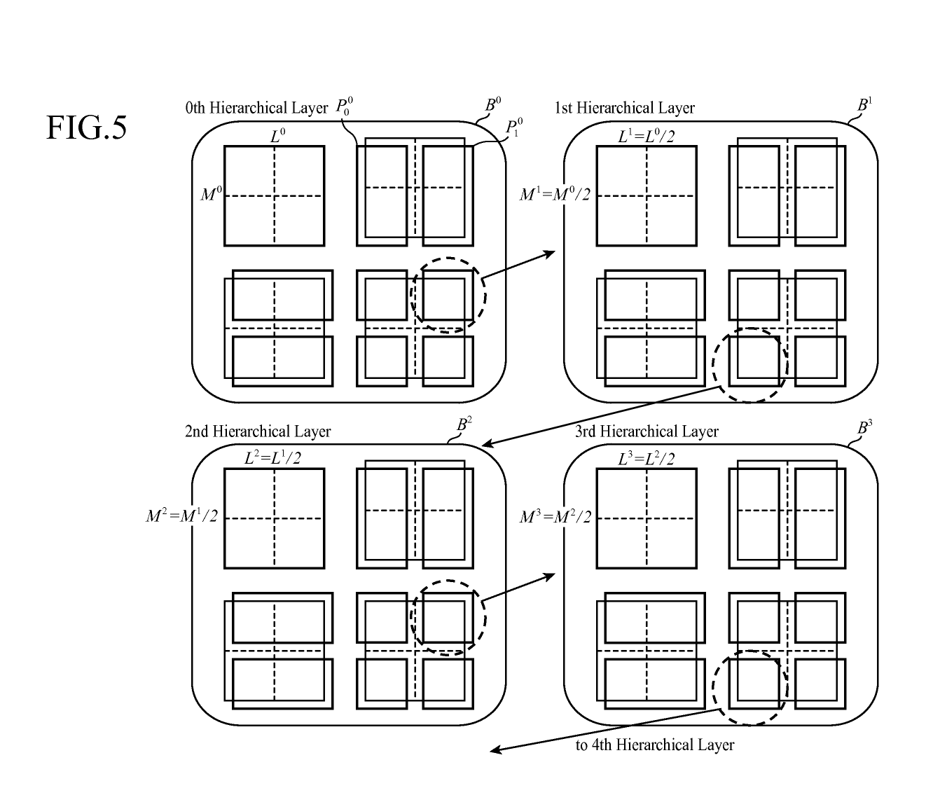

FIG. 5 is an explanatory drawing showing an example in which each largest coding block is hierarchically partitioned into a plurality of coding blocks.

Referring to FIG. 5, each largest coding block is a coding block whose luminance component, which is shown by “0-th hierarchical layer”, has a size of (L⁰, M⁰).

By performing the partitioning hierarchically with each largest coding block being set as a starting point until the depth of the hierarchy reaches a predetermined depth which is set separately according to a quadtree structure, the coding blocks are acquired.

At the depth of n, each coding block is an image region having a size of (Lⁿ, Mⁿ).

Although Lⁿ can be the same as or differ from Mⁿ, the case of Lⁿ=Mⁿ is shown in FIG. 5.

Hereafter, the coding block size determined by the encoding controlling unit 2 is defined as the size of (Lⁿ, Mⁿ) in the luminance component of each coding block.

Because quadtree partitioning is performed, (Lⁿ⁺¹, mⁿ⁺¹)=(Lⁿ/2, Mⁿ/2) is always established.

In the case of a color video signal (4:4:4 format) in which all the color components have the same sample number, such as an RGB signal, all the color components have a size of (Lⁿ, Mⁿ), while in the case of handling a 4:2:0 format, a corresponding color difference component has a coding block size of (Lⁿ/2, Mⁿ/2).

Hereafter, each coding block in the nth hierarchical layer is expressed as Bⁿ, and a coding mode selectable for each coding block Bⁿ is expressed as m(Bⁿ).

In the case of a color video signal which consists of a plurality of color components, the coding mode m(Bⁿ) can be configured in such a way that an individual mode is used for each color component, or can be configured in such a way that a common mode is used for all the color components. Hereafter, an explanation will be made by assuming that the coding mode indicates, unless otherwise specified, a coding mode for the luminance component of each coding block when having a 4:2:0 format in a YUV signal.

Each coding block Bⁿ is partitioned into one or more prediction blocks each representing a unit for prediction process by the block partitioning unit 1, as shown in FIG. 5.

Hereafter, each prediction block belonging to each coding block Bⁿ is expressed as Pᵢⁿ (i shows a prediction block number in the nth hierarchical layer). An example of P00 and P10 is shown in FIG. 5.

How the partitioning of each coding block Bⁿ into prediction blocks is performed is included as information in the coding mode m(Bⁿ).

While a prediction process is performed on each of all the prediction blocks Pᵢⁿ according to the coding mode m(Bⁿ), an individual prediction parameter (an intra prediction parameter or an inter prediction parameter) can be selected for each prediction block Pᵢⁿ.

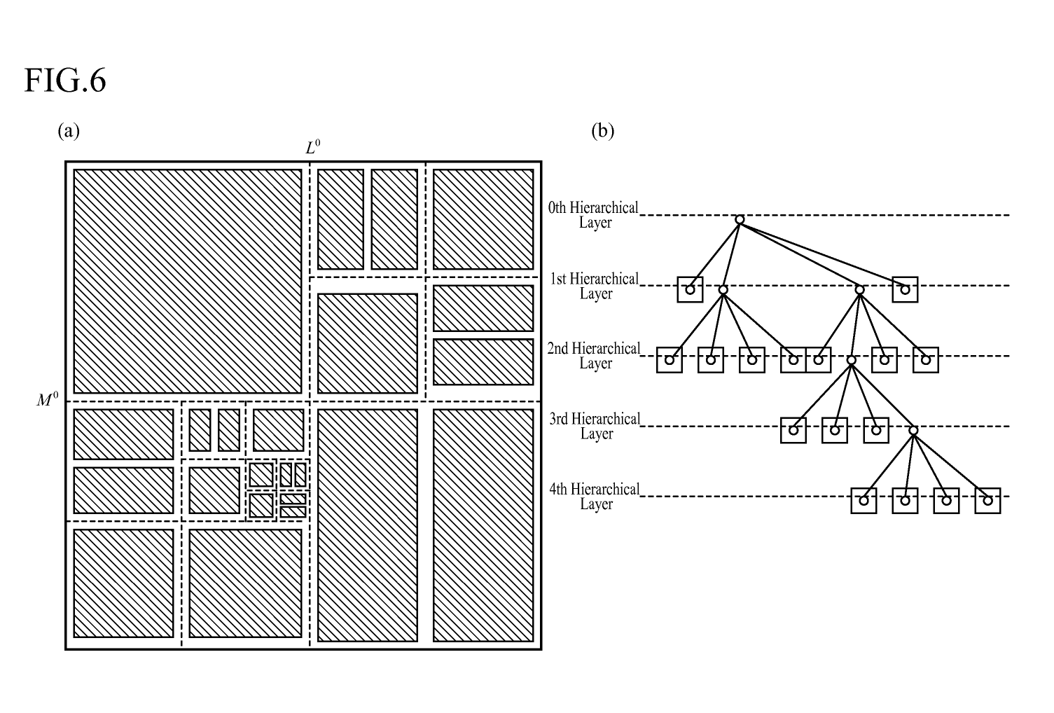

The encoding controlling unit 2 generates such a block partitioning state as shown in FIG. 6 for each largest coding block, and then specifies coding blocks.

Each rectangle enclosed by a dotted line of FIG. 6(a) shows a coding block, and each block filled with hatch lines in each coding block shows the partitioning state of each prediction block.

FIG. 6(b) shows a situation where a coding mode m(Bⁿ) is assigned to each node through the hierarchical layer partitioning in the example of FIG. 6(a) is shown by using a quadtree graph. Each node enclosed by □ shown in FIG. 6(b) is a node (coding block) to which a coding mode m(Bⁿ) is assigned.

Information about this quadtree graph is outputted from the encoding controlling unit 2 to the variable length encoding unit 13 together with the coding mode m(Bⁿ) and is multiplexed into a bitstream.

When the coding mode m(Bⁿ) determined by the encoding controlling unit 2 is an intra coding mode (when m(Bⁿ)εINTRA), the select switch 3 outputs the coding block Bⁿ outputted from the block partitioning unit 1 to the intra prediction unit 4.

In contrast, when the coding mode m(Bⁿ) determined by the encoding controlling unit 2 is an inter coding mode (when m(Bⁿ) εINTER), the select switch outputs the coding block Bⁿ outputted from the block partitioning unit 1 to the motion-compensated prediction unit 5.

When the coding mode m(Bⁿ) determined by the encoding controlling unit 2 is an intra coding mode (when m(Bⁿ)εINTRA), and the intra prediction unit 4 receives the coding block Bⁿ from the select switch 3 (step ST3), the intra prediction unit 4 performs the intra prediction process on each prediction block Pᵢⁿ in the coding block Bⁿ by using the intra prediction parameter determined by the encoding controlling unit 2 while referring to the local decoded image stored in the memory 10 for intra prediction, to generate an intra prediction image P_{INTRAi}ⁿ (step ST4).

Because the video decoding device needs to generate an intra prediction image which is completely the same as the intra prediction image P_{INTRAi}ⁿ, the intra prediction parameter used for the generation of the intra prediction image P_{INTRAi}ⁿ is outputted from the encoding controlling unit 2 to the variable length encoding unit 13, and is multiplexed into the bitstream.

The details of the processing performed by the intra prediction unit 4 will be mentioned below.

When the coding mode m(Bⁿ) determined by the encoding controlling unit 2 is an inter coding mode (when m(Bⁿ)εINTER), and the motion-compensated prediction unit 5 receives the coding block Bⁿ from the select switch 3 (step ST3), the motion-compensated prediction unit 5 compares each prediction block Pᵢⁿ in the coding block Bⁿ with the local decoded image which is stored in the motion-compensated prediction frame memory 12 and on which the filtering process is performed, to search for a motion vector, and performs the inter prediction to process on each prediction block Pᵢⁿ in the coding block Bⁿ by using both the motion vector and the inter prediction parameter determined by the encoding controlling unit 2, to generate an inter prediction image P_{INTERi}ⁿ (step ST5).

Because the video decoding device needs to generate an inter prediction image which is completely the same as the inter prediction image P_{INTERi}ⁿ, the inter prediction parameter used for the generation of the inter prediction image P_{INTERi}ⁿ is outputted from the encoding controlling unit 2 to the variable length encoding unit 13 and is multiplexed into the bitstream.

The motion vector which is searched for by the motion-compensated prediction unit 5 is also outputted to the variable length encoding unit 13 and is multiplexed into the bitstream.

When receiving the coding block Bⁿ from the block partitioning unit 1, the subtracting unit 6 subtracts the intra prediction image P_{INTRAi}ⁿ generated by the intra prediction unit or the inter prediction image P_{INTERi}ⁿ generated by the motion-compensated prediction unit 5 from the prediction block Pᵢⁿ in the coding block Bⁿ, and outputs a prediction difference signal eᵢn showing a difference image which is the result of the subtraction to the transformation/quantization unit 7 (step ST6).

When receiving the prediction difference signal eᵢn from the subtracting unit 6, the transformation/quantization unit 7 refers to the orthogonal transformation block partitioning information included in the prediction difference coding parameters determined by the encoding controlling unit 2, and performs an orthogonal transformation process (e.g., an orthogonal transformation process, such as a DCT (discrete cosine transform), a DST (discrete sine transform), or a KL transform in which bases are designed for a specific learning sequence in advance) for the prediction difference signal eᵢn on each orthogonal transformation block to calculate transform coefficients.

The transformation/quantization unit 7 also refers to the quantization parameter included in the prediction difference coding parameters and quantizes the transform coefficients of each orthogonal transformation block, and outputs compressed data which are the transform coefficients quantized thereby to the inverse quantization/inverse transformation unit 8 and the variable length encoding unit 13 (step ST7). At this time, the transformation/quantization unit can perform the quantization process by using a quantization matrix for performing scaling on the quantization stepsize calculated from the above-mentioned quantization parameter for each transform coefficient.

As the quantization matrix, a matrix which is independent for each chrominance signal and for each coding mode (intra encoding or inter encoding) at each orthogonal transformation size can be used, and either the selection of a quantization matrix from a quantization matrix which is prepared, as an initial value, in advance and in common between the video encoding device and the video decoding device and an already-encoded quantization matrix or the use of a new quantization matrix can be selected.

Therefore, the transformation/quantization unit 7 sets flag information showing whether or not to use a new quantization matrix for each chrominance signal and for each coding mode at each orthogonal transformation size to a quantization matrix parameter to be encoded.

In addition, when a new quantization matrix is used, each of the scaling values in the quantization matrix as shown in FIG. 10 is set to the quantization matrix parameter to be encoded. In contrast, when no new quantization matrix is used, an index specifying a matrix to be used from the quantization matrix which is prepared, as an initial value, in advance and in common between the video encoding device and the video decoding device and an already-encoded quantization matrix is set to the quantization matrix parameter to be encoded. However, when no already-encoded quantization matrix which can be referred to exists, only the quantization matrix prepared in advance and in common between the video encoding device and the video decoding device can be selected.

The transformation/quantization unit 7 then outputs the quantization matrix parameter set thereby to the variable length encoding unit 13.

When receiving the compressed data from the transformation/quantization unit 7, the inverse quantization/inverse transformation unit 8 refers to the quantization parameter and the orthogonal transformation block partitioning information which are included in the prediction difference coding parameters determined by the encoding controlling unit 2, and inverse-quantizes the compressed data for each orthogonal transformation block.

When the transformation/quantization unit 7 uses a quantization matrix for the quantization process, the inverse quantization/inverse transformation unit refers to the quantization matrix and performs a corresponding inverse quantization process also at the time of the inverse quantization process.

The inverse quantization/inverse transformation unit 8 also performs an inverse orthogonal transformation process (e.g., an inverse DCT, an inverse DST, an inverse KL transform, or the like) on the transform coefficients which are the compressed data inverse-quantized for each orthogonal transformation block, and calculates a local decoded prediction difference signal corresponding to the prediction difference signal eᵢn outputted from the subtracting unit 6 and outputs the local decoded prediction difference signal to the adding unit 9 (step ST8).

When receiving the local decoded prediction difference signal from the inverse quantization/inverse transformation unit 8, the adding unit 9 calculates a local decoded image by adding the local decoded prediction difference signal and either the intra prediction image P_{INTRAi}ⁿ generated by the intra prediction unit 4 or the inter prediction image P_{INTERi}ⁿ generated by the motion-compensated prediction unit 5 (step ST9).

The adding unit 9 outputs the local decoded image to the loop filter unit 11 while storing the local decoded image in the memory 10 for intra prediction.

This local decoded image is an encoded image signal which is used at the time of subsequent intra prediction processes.

When receiving the local decoded image from the adding unit 9, the loop filter unit 11 performs the predetermined filtering process on the local decoded image, and stores the local decoded image filtering-processed thereby in the motion-compensated prediction frame memory 12 (step ST10).

Concretely, the loop filter unit performs a filtering (deblocking filtering) process of reducing a distortion occurring at a boundary between orthogonal transformation blocks and a distortion occurring at a boundary between prediction blocks, a process (pixel adaptive offset process) of adaptively adding an offset on a per pixel basis, an adaptive filtering process of performing a filtering process by adaptively switching among linear filters, such as Wiener filters, and so on.

The loop filter unit 11 determines whether or not to perform the process for each of the above-mentioned filtering processes including the deblocking filtering process, the pixel adaptive offset process, and the adaptive filtering process, and outputs the enable flag of each of the processes, as a part of the sequence level header and a part of the slice level header, to the variable length encoding unit 13. When using two or more of the above-mentioned filtering processes, the loop filter unit performs the two or more filtering processes in order. FIG. 11 shows an example of the structure of the loop filter unit 11 in the case of using a plurality of filtering processes.

In general, while the image quality is improved with increase in the number of types of filtering processes used, the processing load is increased conversely. More specifically, there is a trade-off between the image quality and the processing load. Further, an improvement effect of the image quality which is produced by each of the filtering processes differs depending upon the characteristics of the image which is the target for the filtering process. Therefore, what is necessary is just to determine the filtering processes to be used according to the processing load acceptable in the video encoding device and the characteristics of the image which is the target for the filtering process.

In the deblocking filtering process, various parameters used for the selection of the intensity of a filter to be applied to a block boundary can be changed from their initial values. When changing a parameter, the parameter is outputted to the variable length encoding unit 13 as header information.

In the pixel adaptive offset process, the image is partitioned into a plurality of blocks first, a case of not performing the offset process is defined as one class classifying method for each of the coding blocks, and one class classifying method is selected from among a plurality of class classifying methods which are prepared in advance.

Next, by using the selected class classifying method, each pixel included in the block is classified into one of classes, and an offset value for compensating for a coding distortion is calculated for each of the classes.

Finally, the process of adding the offset value to the brightness value of the local decoded image is performed, thereby improving the image quality of the local decoded image.

As the method of performing a class classification, there are a method (referred to as a BO method) of classifying each pixel into one of classes according to the brightness value of the local decoded image, and a method (referred to as an EO method) of classifying each pixel into one of classes according to the state of a neighboring region around the pixel (e.g., whether or not the neighboring region is an edge portion) for each of the directions of edges.

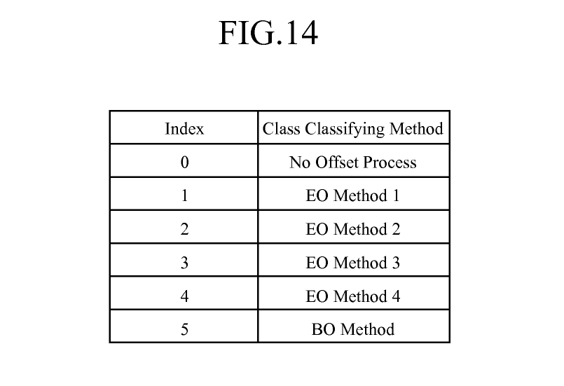

These methods are prepared in common between the video encoding device and the video decoding device. For example, as shown in FIG. 14, the case of not performing the offset process is defined as one class classifying method, and an index indicating which one of these methods is to be used to perform the class classification is selected for each of the above-mentioned blocks.

Therefore, in the pixel adaptive offset process, the block partitioning information, the index indicating the class classifying method for each block, and the offset information for each block are outputted to the variable length encoding unit 13 as header information.

Further, in the adaptive filtering process, a class classification is performed on the local decoded image by using a predetermined method, a filter for compensating for a distortion piggybacked on the image is designed for each region (local decoded image) belonging to each class, and the process of filtering this local decoded image is performed by using the filter.

The filter designed for each class is then outputted to the variable length encoding unit 13 as header information.

As the class classifying method, there are a simple method of partitioning the image into equal parts spatially and a method of performing a classification on a per block basis according to the local characteristics (a variance and so on) of the image. Further, the number of classes used in the adaptive filtering process can be set in advance to be a value common between the video encoding device and the video decoding device, or can be set as a parameter to be encoded.

While the improvement effect of the image quality in the latter case is enhanced as compared with that in the former case because the number of classes used in the latter case can be set freely, the code amount is increased by that required for the number of classes because the number of classes is encoded.

The video encoding device repeatedly performs the processes of steps ST3 to ST9 until the video encoding device completes the processing on all the coding blocks Bⁿ into which the inputted image is partitioned hierarchically, and, when completing the processing on all the coding blocks Bⁿ, shifts to a process of step ST13 (steps ST11 and ST12).

The variable length encoding unit 13 variable-length-encodes the compressed data outputted from the transformation/quantization unit 7, the block partitioning information about the partitioning of each largest coding block, which is outputted from the encoding controlling unit 2 (the quadtree information which is shown in FIG. 6 (b) as an example), the coding mode m(Bⁿ) and the prediction difference coding parameters, the intra prediction parameter (when the coding mode is an intra coding mode) or the inter prediction parameter (when the coding mode is an inter coding mode) outputted from the encoding controlling unit 2, and the motion vector outputted from the motion-compensated prediction unit 5 (when the coding mode is an inter coding mode), and generates encoded data showing those encoded results (step ST13).

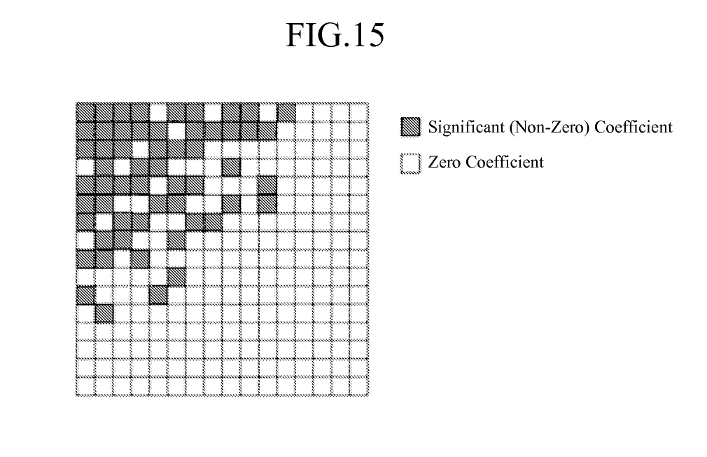

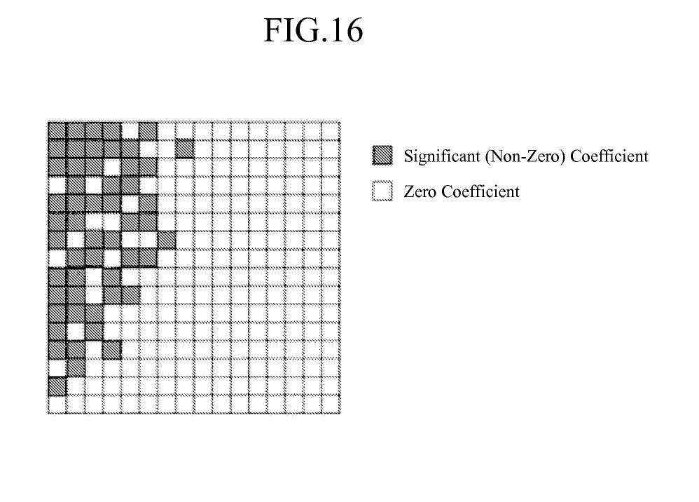

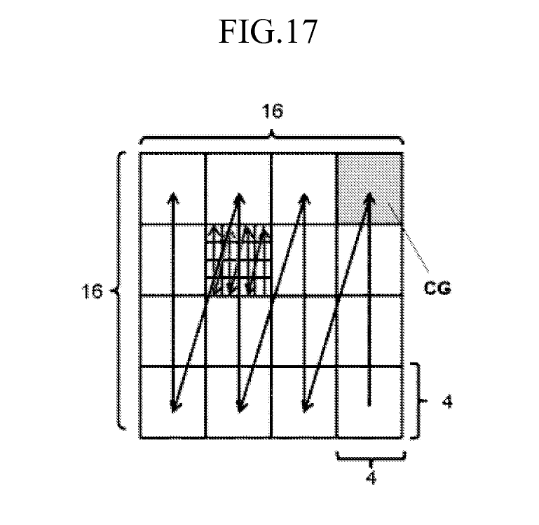

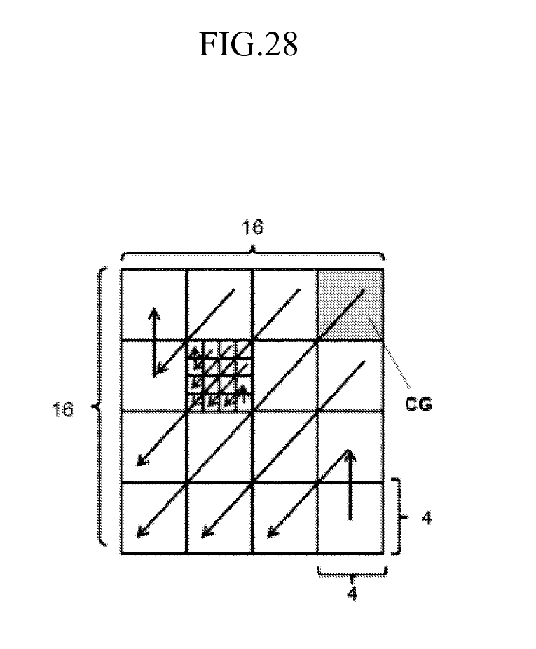

At that time, as a method of encoding the compressed data which are the quantized orthogonal transformation coefficients, each orthogonal transformation block is further partitioned into blocks (coding sub-blocks) of 4×4 pixels each of which is called a Coefficient Group (CG), and a process of encoding the coefficients is performed on a per CG basis. The order (scanning order) of encoding the coefficients in each 16×16 pixel orthogonal transformation block is shown in FIG. 28. According to the non-cited document 2, a process of encoding 16 CGs of 4×4 pixels is performed in order from the CG at the lower right corner in this way, and the 16 coefficients in each CG are further encoded in order from the coefficient at the lower right corner. Concretely, flag information showing whether a significant (non-zero) coefficient exists in the 16 coefficients in the CG is encoded first, whether or not each coefficient in the CG is a significant (non-zero) coefficient is then encoded in the above-mentioned order only when a significant (non-zero) coefficient exists in the CG, and, for each significant (non-zero) coefficient, information about its coefficient value is finally encoded in order. This process is performed in the above-mentioned order on a per CG basis. At that time, it is preferable to configure the scanning order in such a way that significant (non-zero) coefficients appear as consecutively as possible, thereby being able to improve the coding efficiency according to the entropy encoding. Because the coefficients after orthogonal transformation, starting with the dc component located at the upper left corner, represent the coefficients of components having a frequency which decreases as they approach the upper left corner, and therefore, in general, significant (non-zero) coefficients appear more frequently as they approach the upper left corner in a progressive video, as shown in the example shown in FIG. 15, the coefficients can be encoded efficiently by encoding them in order from the coefficient at the lower right corner, as shown in FIG. 28. In contrast, when the flag of a sequence level header showing whether or not the field encoding is performed is valid, more specifically, when the input signal is encoded on a per field basis, the prediction efficiency in the vertical direction degrades because of reduction of the spatial correlation in the vertical direction, many vertical frequency components appear also in the transform coefficients which are the result of performing orthogonal transformation on the prediction difference signal eᵢn, and, as shown in the example shown in FIG. 16, there is a tendency for the appearance distribution of significant (non-zero) coefficients to be biased toward the left-hand side of each orthogonal transformation block, as compared with that of a progressive video. Therefore, because the encoding cannot be performed efficiently in the case of using the encoding order shown in FIG. 28, switching to an encoding order shown in FIG. 17 is performed, for example. By doing in this way, the encoding of significant (non-zero) coefficients is processed continuously in later steps in the encoding order, and the coding efficiency according to the entropy encoding can be improved.

Although 16×16 pixel orthogonal transformation blocks are explained in the above-mentioned example, an encoding process for each CG (coding sub-block) is assumed to be performed also on blocks having a size other than 16×16 pixels, such as 32×32 pixel orthogonal transformation blocks, and the encoding order is changed according to whether or not the flag of a sequence level header showing whether or not the field encoding is performed is valid, like in the case of 16×16 pixel orthogonal transformation blocks.

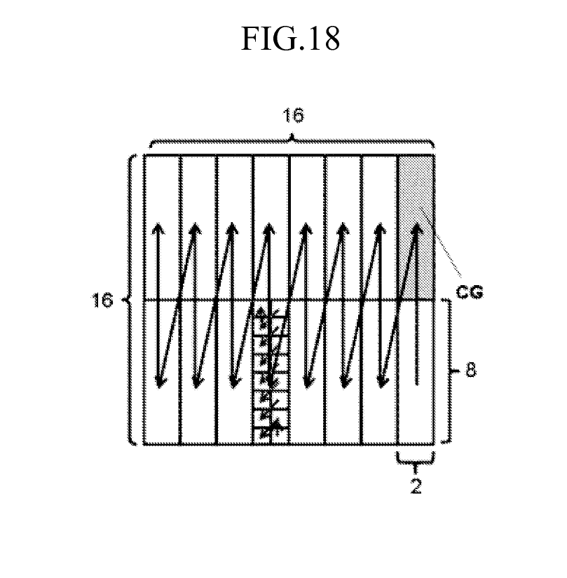

Although in the above-mentioned example, the encoding order is switched to the encoding order shown in FIG. 17 (for each coding block (the encoding order in each 16×16 pixel coding block), and for each coding sub-block (the encoding order in each 4×4 pixel CG)) when the flag of a sequence level header showing whether or not the field encoding is performed is valid, the shape of CGs can be changed from a 4×4 pixel block to a 8×2 pixel block, as shown in FIG. 18. Also by doing in this way, the encoding of significant (non-zero) coefficients is processed continuously in later CGs in the encoding order, and the coding efficiency according to the entropy coding can be improved. More specifically, when the flag of a sequence level header showing whether or not the field encoding is performed is invalid, because the encoding order is as shown in FIG. 28, the encoding order is changed on a per coding block basis and on a per coding sub-block basis in the case of FIG. 17, and therefore the coding efficiency can be improved. Further, in the case of FIG. 18, because the shape of the coding sub-blocks is also changed in addition to changing the encoding order on a per coding block basis and on a per coding sub-block basis, the coding efficiency can be further improved. Although the case of changing the encoding order both on a per coding block basis and on a per coding sub-block basis is explained in the above-mentioned example, the changing of the encoding order only either on a per coding block basis or on a per coding sub-block basis can be alternatively implemented.

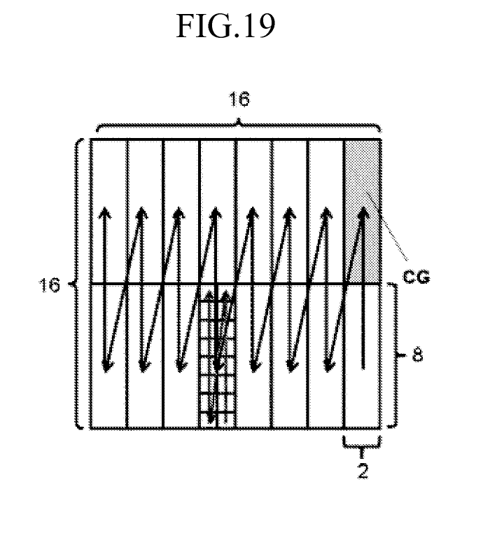

As an alternative, when the flag of a sequence level header showing whether or not the field encoding is performed is valid, the encoding order can be switched to an encoding order shown in FIG. 19. Thus, by not only changing the shape of CGs, but also changing the scanning order in each CG while giving a higher priority to coefficients on a right-hand side of the block, the encoding of significant (non-zero) coefficients can be processed continuously in further later steps in the encoding order, and the coding efficiency according to the entropy coding can be further improved.

The flag of a sequence level header showing whether or not the field encoding is performed can be prepared in each picture level header to adaptively change the encoding order of the coefficients at the time of encoding the compressed data, which are the quantized orthogonal transformation coefficients, on a per picture basis. By doing in this way, the adaptive control can be implemented on a per picture basis, and the coding efficiency can be improved. It is necessary to prepare the above-mentioned flag in each picture level header when implementing the encoding of adaptively switching between the frame encoding and the field encoding on a per picture basis.

Further, although the case in which the encoding order, the shape, and so on are changed on the basis of the flag of a sequence level header or a picture level header showing whether or not the field encoding is performed is explained in this Embodiment 1, a flag showing whether or not this switching process is performed can be defined independently from the flag of a sequence level header or a picture level header showing whether or not the field encoding is performed, and the encoding order, the shape of CGs, the scanning order in each CG, and so on can be changed on the basis of the flag showing whether or not this switching process is performed.

Further, although FIGS. 17, 18, and 19 are illustrated as examples of the encoding order, the shape of CGs, and the scanning order in each CG, they are not limited to these examples, and the encoding order, the shape of CGs, and the scanning order in each CG can be set to other than those shown in FIGS. 17, 18, and 19 as long as the encoding of significant (non-zero) coefficients can be processed continuously in later steps in the encoding order. Further, the combination of the shape of CGs and the scanning order in each CG is not limited to the examples shown in FIGS. 17, 18, and 19. For example, CGs can be 1×2, 1×4, 1×8, 1×16, 2×2, 2×4, 4×8 pixels, or the like.

Further, although the case in which any one (unselectable) of the examples shown in FIGS. 17, 18, and 19 is implemented in the field encoding is explained in this Embodiment 1, one candidate can be selected from a plurality of candidates (FIGS. 17, 18, 19, etc.). In this case, a flag showing which candidate is selected from the plurality of candidates is prepared in the above-mentioned header. This flag can serve as the flag showing whether or not the field encoding is performed or the flag showing whether or not this switching process is performed.

The variable length encoding unit 13 also encodes sequence level headers and picture level headers as header information of an encoded bitstream, as illustrated in FIG. 13, and generates an encoded bitstream as well as picture data.

Picture data consists of one or more slice data, and each slice data is a combination of a slice level header and the above-mentioned encoded data existing in the slice currently being processed.

A sequence level header is generally a combination of pieces of header information which are common on a per sequence basis, the pieces of header information including the image size, the chrominance signal format, the bit depths of the signal values of the luminance signal and the color difference signals, and the enable flag information about each of the filtering processes (the adaptive filtering process, the pixel adaptive offset process, and the deblocking filtering process) which are performed on a per sequence basis by the loop filter unit 11, the enable flag information of the quantization matrix, the flag showing whether or not the field encoding is performed, and so on.

A picture level header is a combination of pieces of header information which are set on a per picture basis, the pieces of header information including an index indicating a sequence level header to be referred to, the number of reference pictures at the time of motion compensation, a probability table initialization flag for entropy coding, and so on.

A slice level header is a combination of parameters which are set on a per slice basis, the parameters including position information showing at which position of the picture the slice currently being processed exists, an index indicating which picture level header is to be referred to, the coding type of the slice (all intra coding, inter coding, or the like), the flag information showing whether or not to perform each of the filtering processes in the loop filter unit 11 (the adaptive filtering process, the pixel adaptive offset process, and the deblocking filtering process), and so on.

Next, the process performed by the intra prediction unit 4 will be explained in detail.

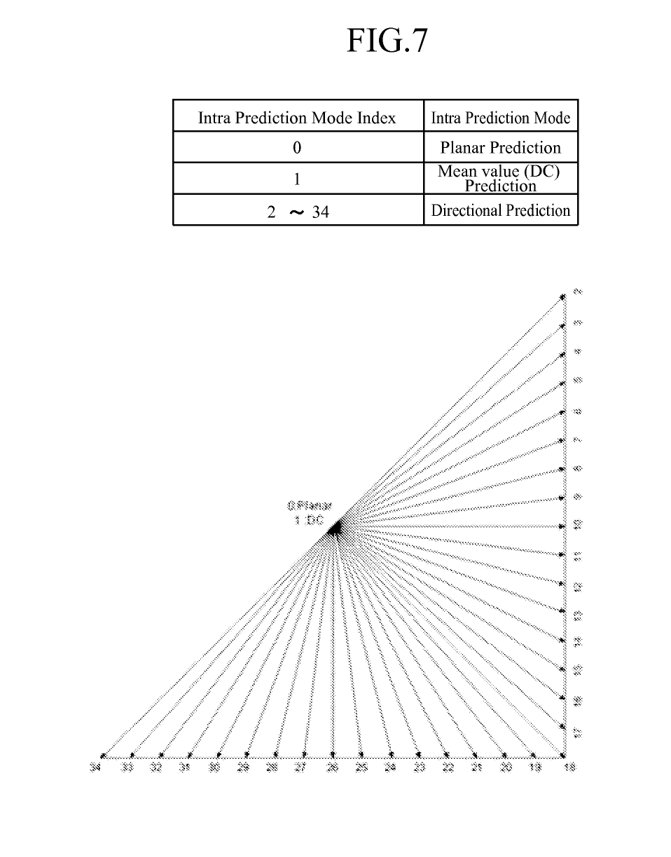

FIG. 7 is an explanatory drawing showing an example of intra prediction modes each of which is an intra prediction parameter which can be selected for each prediction block Pᵢⁿ in the coding block Bⁿ.

In the figure, N_{I} shows the number of intra prediction modes.

In FIG. 7, the index values of the intra prediction modes and prediction direction vectors respectively indicated by the intra prediction modes are shown.

In the example of FIG. 7, it is designed that the relative angles between the prediction direction vectors become small with increase in the number of selectable intra prediction modes.

The intra prediction unit 4 refers to the intra prediction parameter of each prediction block Pᵢⁿ and performs the intra prediction process on the prediction block Pᵢⁿ to generate an intra prediction image P_{INTRAi}ⁿ as mentioned above. Hereafter, an intra process of generating an intra prediction signal of a prediction block Pᵢⁿ in the luminance signal will be explained.

It is assumed that the size of the prediction block Pᵢⁿ is lᵢⁿ×mᵢⁿ pixels.

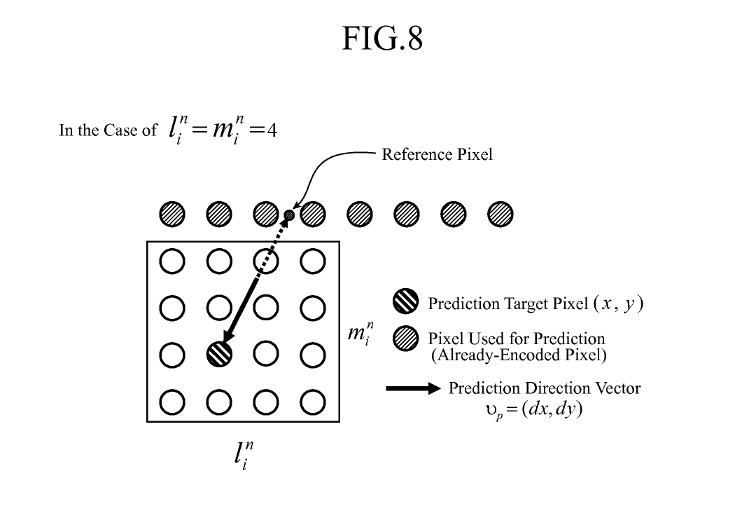

FIG. 8 is an explanatory drawing showing an example of pixels which are used when generating a predicted value of each pixel in the prediction block Pᵢⁿ in the case of lᵢⁿ=mᵢⁿ=4

Although (2×lᵢn+1) already-encoded pixels located on the top of the prediction block Pᵢⁿ and (2×mᵢn) already-encoded pixels located to the left of the prediction block Pᵢⁿ are set as the pixels used for prediction in the example of FIG. 8, a larger or smaller number of pixels than the pixels shown in FIG. 8 can be used for prediction.

Further, although one row or column of pixels adjacent to the prediction block Pᵢⁿ are used for prediction in the example shown in FIG. 8, two or more rows or columns of pixels can be alternatively used for prediction.

When the index value indicating the intra prediction mode for the prediction block Pᵢⁿ is 0 (planar prediction), by using already-encoded pixels adjacent to the top of the prediction block Pᵢⁿ and already-encoded pixels adjacent to the left of the prediction block Pᵢⁿ, the intra prediction unit determines a value interpolated according to the distances between these pixels and the target pixel to be predicted in the prediction block Pᵢⁿ as a predicted value and generates a prediction image.

When the index value indicating the intra prediction mode for the prediction block Pᵢⁿ is 2 (mean value (DC) prediction), the intra prediction unit determines the mean value of the already-encoded pixels adjacent to the top of the prediction block Pᵢⁿ and the already-encoded pixels adjacent to the left of the prediction block Pᵢⁿ as the predicted value of each pixel in the prediction block Pᵢⁿ and generates a prediction image.

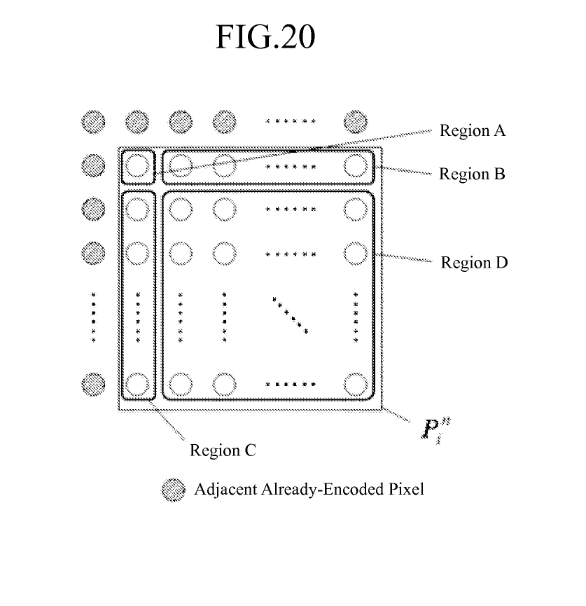

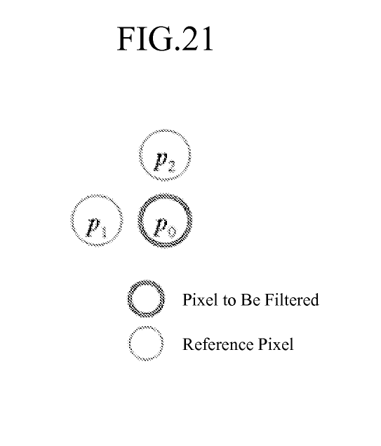

In addition, a filtering process of smoothing a block boundary is performed on regions A, B, and C of FIG. 20 located at the upper edge and at the left edge of the prediction block Pᵢⁿ, and a final prediction image is generated. For example, in the case of the arrangement, as shown in FIG. 21, of reference pixels of the filter, the filtering process is performed by using the following filter coefficients.

Region A (the pixel at the upper left corner of the partition Pᵢⁿ)

a₀=½,a₁=¼,a₂=¼

Region B (the pixels at the upper edge of the partition Pᵢⁿ, except the region A)

a₀=¾,a₂=¼,(a₁=0)

Region C (the pixels at the left edge of the partition Pᵢⁿ, except the region A)

a₀=¾,a₂=¼,(a₂=0)

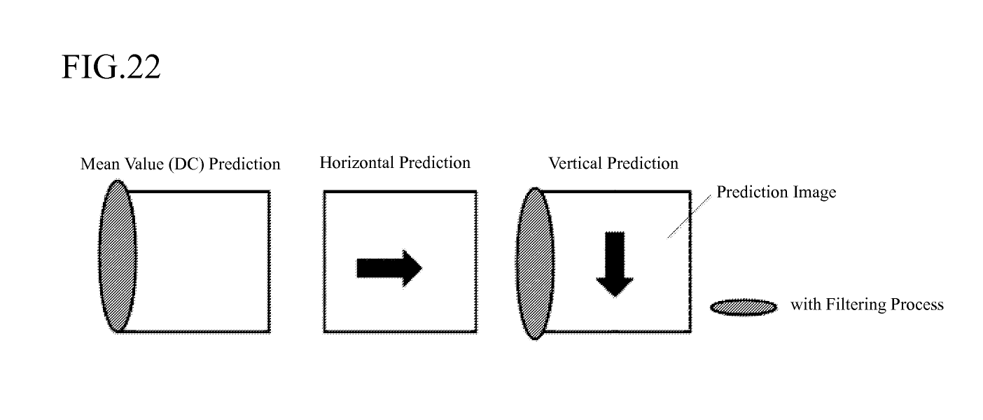

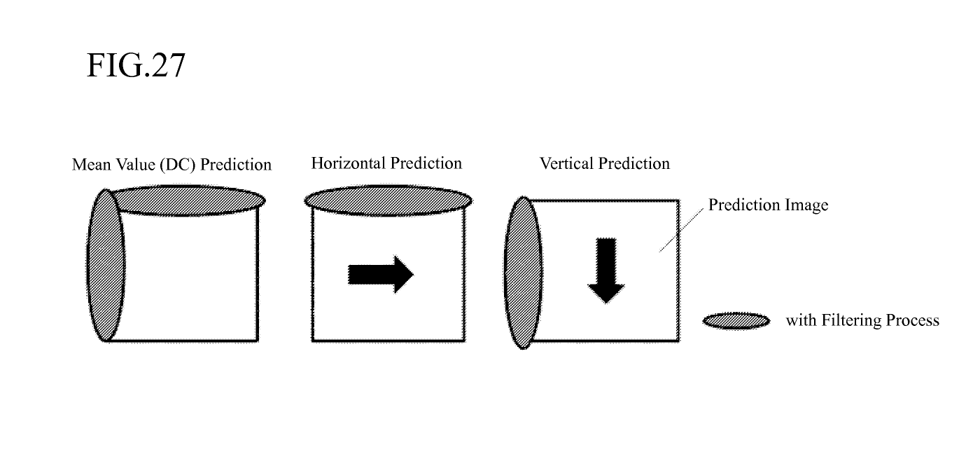

When the flag of a sequence level header showing whether or not the field encoding is performed is valid, the filtering process is not performed on the upper edge of the prediction block, as shown in FIG. 22. In the case of the field encoding, there is a possibility that because the correlation between pixels in a vertical direction is low, the prediction efficiency gets worse due to a filtering process in a horizontal prediction of FIG. 27. Therefore, by performing the filtering process only on the regions A and C, but not performing the filtering process on the region B, the amount of computations can be reduced while a reduction of the prediction efficiency is prevented.

Although in the above-mentioned example, the filtering process is performed only on the regions A and C when the flag of a sequence level header showing whether or not the field encoding is performed is valid, the same filtering process as that on the region C can be performed also on the region A. Thus, by not using pixels in the vertical direction having a low correlation between the pixels, the possibility of reduction of the prediction efficiency can be further lowered while the amount of computations required for the filtering process can be reduced. As an alternative, when attaching importance to a further reduction of the amount of computations, no filtering process can be performed also on the region A and the filtering process can be performed only on the region C.

When the index value indicating the intra prediction mode for the prediction block Pᵢⁿ is 26 (vertical prediction), the intra prediction unit calculates the predicted value of each pixel in the prediction block Pᵢⁿ according to the following equation (1), and generates a prediction image.

$${S}^{′} ( x , y ) = \{ \begin{matrix}S ( x , - 1 ) + ( S ( - 1 , y ) - S ( - 1 , - 1 ) ) >> 1 ( x \leq 0 ) \\ S ( x , - 1 ) ( x \leq 0 )\end{matrix} \qquad ( 1 )$$

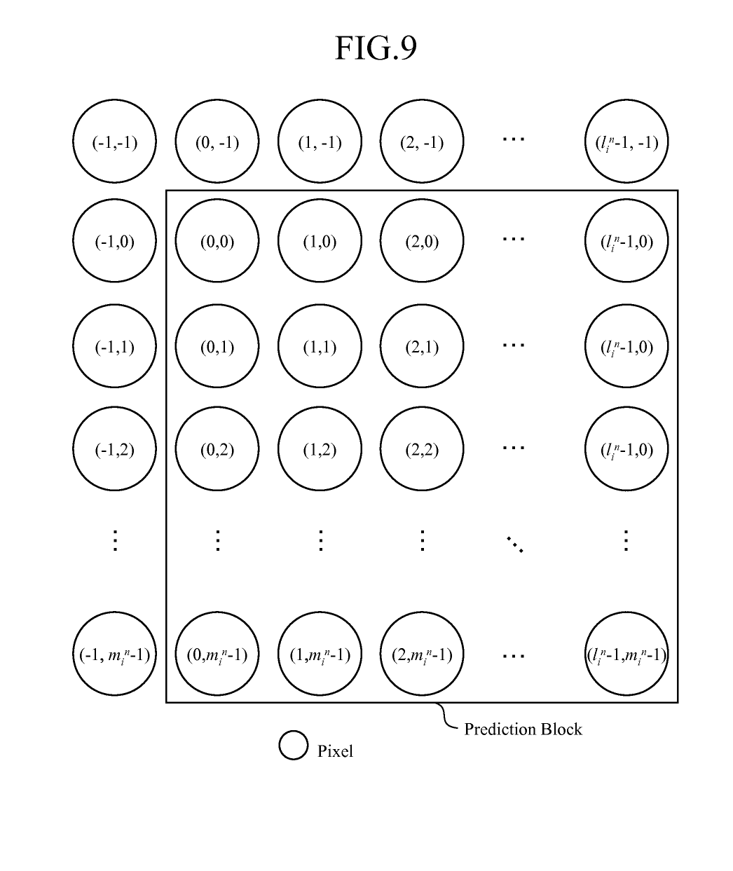

In this equation, coordinates (x, y) are relative coordinates (refer to FIG. 9) acquired with the pixel at the upper left corner in the prediction block Pᵢn being defined as the point of origin, S′(x, y) is the predicted value at the coordinates (x, y), and S(x, y) is the brightness value (decoded brightness value) of the already-encoded pixel at the coordinates (x, y). Further, when the calculated predicted value exceeds a range of values which the brightness value can have, the predicted value is rounded in such a way as to fall within the range.

The equation (1) shows a filtering process in the vertical prediction of FIG. 27. Concretely, an expression in the first line of the equation (1) means that by adding a value which is one-half of the amount of change in the vertical direction of the brightness values of adjacent already-encoded pixels to S(x, −1) which is the predicted value acquired by the vertical prediction in MPEG-4 AVC/H.264, the filtering process is performed in such a way that a block boundary is smoothed, and an expression in the second line of the equation (1) shows the same prediction expression as that for the vertical prediction in MPEG-4 AVC/H.264.

When the index value indicating the intra prediction mode for the prediction block Pᵢn is 10 (horizontal prediction), the intra prediction unit calculates the predicted value of each pixel in the prediction block Pᵢⁿ according to the following equation (2), and generates a prediction image.

$${S}^{′} ( x , y ) = \{ \begin{matrix}S ( - 1 , y ) + ( S ( x , - 1 ) - S ( - 1 , - 1 ) ) >> 1 ( y \leq 0 ) \\ S ( - 1 , y ) ( y > 0 )\end{matrix} \qquad ( 2 )$$

In this equation, coordinates (x, y) are relative coordinates (refer to FIG. 9) acquired with the pixel at the upper left corner in the prediction block Pᵢⁿ being defined as the point of origin, S′(x, y) is the predicted value at the coordinates (x, y), and S(x, y) is the brightness value (decoded brightness value) of the already-encoded pixel at the coordinates (x, y). Further, when the calculated predicted value exceeds a range of values which the brightness value can have, the predicted value is rounded in such a way as to fall within the range.

The equation (2) shows a filtering process in the horizontal prediction of FIG. 27. Concretely, an expression in the first line of the equation (2) means that by adding a value which is one-half of the amount of change in the horizontal direction of the brightness values of adjacent already-encoded pixels to S(−1, y) which is the predicted value acquired by the horizontal prediction in MPEG-4 AVC/H.264, the filtering process is performed in such a way that a block boundary is smoothed, and an expression in the second line of the equation (2) shows the same prediction expression as that for the horizontal prediction in MPEG-4 AVC/H.264.

When the flag of a sequence level header showing whether or not the field encoding is performed is valid, an equation (3), instead of the equation (2), is used for the horizontal prediction.

S′(x,y)=S)−1,7) (3)

More specifically, no filtering process is performed on the upper edge of the prediction block, as shown in FIG. 22 (both in the case of the mean value prediction and in the case of the vertical prediction, the filtering process is performed only on the left edge of the prediction block, whereas in the case of the horizontal prediction, no filtering process is performed). In the case of the field encoding, there is a possibility that because the correlation between pixels in the vertical direction is low, an improvement of the continuity at a block boundary by using the filtering process in the horizontal prediction of FIG. 27 reduces the prediction efficiency. Accordingly, by not performing the above-mentioned filtering process, the amount of computations can be reduced while a reduction of the prediction efficiency is prevented.

The flag of a sequence level header showing whether or not the field encoding is performed can be prepared for each picture level header, and the ON/OFF switching of the filtering process on the upper edge of each prediction block of each picture in the mean value (DC) prediction and in the horizontal prediction can be performed according to the correlation between pixels in the vertical direction. By doing in this way, the adaptive control can be implemented on a per picture basis, and the coding efficiency can be improved. It is necessary to prepare the above-mentioned flag in each picture level header when implementing the encoding of adaptively switching between the frame encoding and the field encoding on a per picture basis.

Further, although the case in which the ON/OFF of the filtering process on the upper edge of each prediction block is switched on the basis of the flag of a sequence level header or a picture level header showing whether or not the field encoding is performed is explained in this Embodiment 1, a flag showing whether or not this switching process is performed can be defined independently from the flag of a sequence level header or a picture level header showing whether or not the field encoding is performed, and the ON/OFF of the filtering process on the upper edge of each prediction block can be switched on the basis of the flag showing whether or not this switching process is performed. The flag showing whether or not this switching process is performed is based on the flag showing whether or not the field encoding is performed.

Further, although the changing of the encoding order explained previously and the above-mentioned switching of the filtering process are explained separately in this Embodiment 1, these processes can be combined and configured.

Further, the size of blocks on which the filtering process is performed can be limited. For example, the filtering process on a block boundary in the mean value (DC) prediction, in the vertical prediction, and in the horizontal prediction is performed only on, for example, blocks of 16×16 pixels or less. By doing in this way, the amount of computations required for the filtering process can be reduced.

When the index value indicating the intra prediction mode is other than 0 (planar prediction), 2 (mean value prediction), 26 (vertical prediction), and 10 (horizontal prediction), the intra prediction unit generates the predicted value of each pixel in the prediction block Pᵢⁿ on the basis of a prediction direction vector uₚ=(dx, dy) shown by the index value.

As shown in FIG. 9, when the relative coordinates of each pixel in the prediction block Pᵢⁿ are expressed as (x, y) with the pixel at the upper left corner of the prediction block Pᵢⁿ being defined as the point of origin, each reference pixel which is used for prediction is located at a point of intersection of L shown below and an adjacent pixel.

$$L = ( \begin{matrix}x \\ y\end{matrix} ) + {kv}_{p} \qquad ( 4 )$$

where k is a negative scalar value.

When a reference pixel is at an integer pixel position, the value of the corresponding integer pixel is determined as the predicted value of the target pixel to be predicted, whereas when a reference pixel is not at an integer pixel position, the value of an interpolation pixel generated from the integer pixels which are adjacent to the reference pixel is determined as the predicted value.

In the example shown in FIG. 8, because a reference pixel is not located at an integer pixel position, the predicted value is interpolated from the values of two pixels adjacent to the reference pixel. The intra prediction unit can use, instead of only the adjacent two pixels, adjacent two or more pixels to generate an interpolation pixel and determine the value of this interpolation pixel as the predicted value.

While the increase in the number of pixels used for the interpolation process provides an advantage of improving the accuracy of interpolation of an interpolation pixel, because the degree of complexity of computations required for the interpolation process increases, it is preferable to generate an interpolation pixel from a larger number of pixels in a case in which the video encoding device requires high encoding performance even if the arithmetic load is large.

Through the process described above, the intra prediction unit generates prediction pixels for all the pixels of the luminance signal in the prediction block Pᵢⁿ, and outputs an intra prediction image P_{INTRAi}ⁿ.

The intra prediction parameter (intra prediction mode) used for the generation of the intra prediction image P_{INTRAi}ⁿ is outputted to the variable length encoding unit 13 in order to multiplex the intra prediction parameter into the bitstream.

Like in the case of performing a smoothing process on a reference image at the time of performing an intra prediction on an 8×8-pixel block in MPEG-4 AVC/H.264 explained previously, even if the intra prediction unit 4 is configured in such a way that an already-encoded pixel adjacent to the prediction block Pᵢⁿ on which a smoothing process is performed is provided as the reference pixel at the time of generating an intermediate prediction image of the prediction block Pᵢⁿ, the filtering process which is the same as that in the above-mentioned example can be performed on the intermediate prediction image.

The intra prediction unit also performs an intra prediction process based on the intra prediction parameter (intra prediction mode) on each of the color difference signals of the prediction block Pᵢⁿ according to the same procedure as that for the luminance signal, and outputs the intra prediction parameter used for the generation of the intra prediction image to the variable length encoding unit 13.

However, selectable intra prediction parameters (intra prediction modes) for each of the color difference signals can differ from those for the luminance signal. For example, in order to reduce the amount of computations, the same prediction method as that for use in MPEG-4 AVC/H.264 can be used for the vertical prediction and the horizontal prediction of the color difference signals without performing the filtering process on a block boundary. In the case of a YUV signal having a 4:2:0 format, each of the color difference signals (U and V signals) is the one whose resolution is reduced to one-half that of the luminance signal (Y signal) both in the horizontal direction and in the vertical direction, and the complexity of each of the color difference signals is lower than that of the luminance signal and hence a prediction is performed more easily. Therefore, by reducing the number of selectable intra prediction parameters for each of the color difference signals to be smaller than that for the luminance signal, a reduction of the code amount required to encode the intra prediction parameter and a reduction of the amount of computations required to perform the prediction process can be implemented.

Next, the processing performed by the video decoding device shown in FIG. 3 will be explained concretely.

When receiving the encoded bitstream generated by the video encoding device shown in FIG. 1, the variable length decoding unit 31 performs a variable length decoding process on the bitstream (step ST21 of FIG. 4) and decodes the header information (sequence level header) about each sequence consisting of one or more frames of pictures, the header information including the flag showing whether or not the field encoding is performed and the information about the frame size, the header information (picture level header) about each picture, the filter parameters for use in the loop filter unit 38, and the quantization matrix parameter.

At this time, the video decoding device refers to the quantization matrix parameter variable-length-decoded by the variable length decoding unit 31 to specify the quantization matrix. Concretely, for each chrominance signal and for each coding mode at each orthogonal transformation size, when the quantization matrix parameter shows that either a quantization matrix which is prepared, as an initial value, in advance and in common between the video encoding device and the video decoding device, or an already-decoded quantization matrix is used (no new quantization matrix is used), the video decoding device refers to the index information included in the quantization matrix parameter and specifying which quantization matrix in the above-mentioned matrices is used, to specify the quantization matrix, and, when the quantization matrix parameter shows that a new quantization matrix is used, specifies, as the quantization matrix to be used, the quantization matrix included in the quantization matrix parameter.

The video decoding device then decodes the header information about each slice (slice level header), such as the slice partitioning information, from each slice data which constructs the data about each picture, and decodes the encoded data about each slice.

The variable length decoding unit 31 also determines the largest coding block size and the upper limit on the number of hierarchical layers partitioned which are determined by the encoding controlling unit 2 of the video encoding device shown in FIG. 1 according to the same procedure as that of the video encoding device (step ST22).

For example, when the largest coding block size and the upper limit on the number of hierarchical layers partitioned are determined according to the resolution of the video signal, the variable length decoding unit determines the largest coding block size on the basis of the decoded frame size information and according to the same procedure as that of the video encoding device.

When the largest coding block size and the upper limit on the number of hierarchical layers partitioned are multiplexed into each sequence level header or the like by the video encoding device, the variable length decoding unit uses the values decoded from the above-mentioned header.

Hereafter, the above-mentioned largest coding block size is referred to as the largest decoding block size, and a largest coding block is referred to as a largest decoding block in the video decoding device.

The variable length decoding unit 31 decodes the partitioning state of a largest decoding block as shown in FIG. 6 for each determined largest decoding block.

The variable length decoding unit hierarchically specifies decoding blocks (i.e., blocks corresponding to “coding blocks” in the video encoding device shown in FIG. 1) on the basis of the decoded partitioning state (step ST23).

The variable length decoding unit 31 then decodes the coding mode assigned to each decoding block. The variable length decoding unit further partitions each decoding block into one or more prediction blocks each of which is a unit for prediction process on the basis of the information included in the decoded coding mode, and decodes the prediction parameter assigned to each of the one or more prediction blocks (step ST24).

More specifically, when the coding mode assigned to a decoding block is an intra coding mode, the variable length decoding unit 31 decodes the intra prediction parameter for each of the one or more prediction blocks which are included in the decoding block and each of which is a unit for prediction process.

In contrast, when the coding mode assigned to a decoding block is an inter coding mode, the variable length decoding unit decodes the inter prediction parameter and the motion vector for each of the one or more prediction blocks which are included in the decoding block and each of which is a unit for prediction process (step ST24).

The variable length decoding unit 31 further decodes the compressed data (transformed and quantized transform coefficients) of each orthogonal transformation block on the basis of the orthogonal transformation block partitioning information included in the prediction difference coding parameters (step ST24).

At that time, the variable length decoding unit performs a process of decoding the coefficients of each CG in the same way that the variable length encoding unit 13 of the video encoding device of FIG. 1 performs the process of encoding the compressed data. Therefore, as shown in FIG. 28, the variable length decoding unit generally performs a process of decoding 16 CGs of 4×4 pixels in order from the CG at the lower right corner, and further decodes the 16 coefficients in each CG in order from the coefficient at the lower right corner. Concretely, the flag information showing whether a significant (non-zero) coefficient exists in the 16 coefficients in the CG is decoded first, whether or not each coefficient in the CG is a significant (non-zero) coefficient is then decoded in the above-mentioned order only when the decoded flag information shows that a significant (non-zero) coefficient exists in the CG, and, for each coefficient showing a significant (non-zero) coefficient, information about the coefficient value is finally decoded in order. This process is performed in the above-mentioned order on a per CG basis. When the flag of a sequence level header showing whether or not the field encoding is performed is valid, the sequence level header being decoded by the variable length decoding unit 31, the decoding process is performed in the same order as the processing order, as shown in FIG. 17, 18, or 19, determined by the variable length encoding unit 13 of the video encoding device of FIG. 1. By doing in this way, the same compressed data as those of the stream generated by the video encoding device of FIG. 1 can be generated.

When the flag of a sequence level header showing whether or not the field encoding is performed is prepared for each picture level header and the variable length encoding unit 13 of the video encoding device of FIG. 1 is configured in such a way as to adaptively change the order of encoding the coefficients at the time of encoding the compressed data, which are the quantized orthogonal transformation coefficients, on a per picture basis, the variable length decoding unit 31 is also configured in such a way as to similarly and adaptively change the order of decoding the compressed data on a per picture basis according to the above-mentioned flag.

When the coding mode m(Bⁿ) variable-length-decoded by the variable length decoding unit 31 is an intra coding mode (when m(Bⁿ)εINTRA) the select switch 33 outputs the intra prediction parameter of each prediction block, which is variable-length-decoded by the variable length decoding unit 31, to the intra prediction unit 34.

In contrast, when the coding mode m(Bⁿ) variable-length-decoded by the variable length decoding unit 31 is an inter coding mode (when m(B^{e})εINTER) the select switch outputs the inter prediction parameter and the motion vector of each prediction block, which are variable-length-decoded by the variable length decoding unit 31, to the motion compensation unit 35.

When the coding mode m(Bⁿ) variable-length-decoded by the variable length decoding unit 31 is an intra coding mode (m(Bⁿ) εINTRA) (step ST25) the intra prediction unit 34 receives the intra prediction parameter of each prediction block outputted from the select switch 33, and performs an intra prediction process on each prediction block Pᵢⁿ in the decoding block Bⁿ using the above-mentioned intra prediction parameter while referring to the decoded image stored in the memory 37 for intra prediction, to generate an intra prediction image P_{INTRAi}ⁿ according to the same procedure as that of the intra prediction unit 4 shown in FIG. 1 (step ST26).

The video decoding device is configured in such a way as to, when the flag of a sequence level header showing whether or not the field encoding is performed is valid, the sequence level header being decoded by the variable length decoding unit 31, not perform a filtering process on the upper edge of each prediction block in the mean value (DC) prediction and in the horizontal prediction, like the video encoding device of FIG. 1. By doing in this way, the same prediction image as the stream generated by the video encoding device of FIG. 1 can be generated.

When the flag of a sequence level header showing whether or not the field encoding is performed is prepared for each picture level header in the video encoding device in accordance with Embodiment 1, according to the value of this flag, in each picture level header, showing whether or not the field encoding is performed, the ON/OFF switching of the filtering process on the upper edge of each prediction block in the mean value (DC) prediction and in the horizontal prediction is performed on a per picture basis. By doing in this way, the same prediction image as the stream generated by the video encoding device in accordance with Embodiment 1 constructed as above can be generated.

When the coding mode m(Bⁿ) variable-length-decoded by the variable length decoding unit 31 is an inter coding mode (m(Bⁿ) SINTER) (step ST25), the motion compensation unit 35 receives the motion vector and the inter prediction parameter of each prediction block which are outputted from the select switch 33, and performs an inter prediction process on each prediction block Pᵢⁿ in the decoding block Bⁿ using the motion vector and the inter prediction parameter while referring to the decoded image stored in the motion-compensated prediction frame memory 39 and on which the filtering process is performed, to generate an inter prediction image P_{INTERi}ⁿ (step ST27).

When receiving the compressed data and the prediction difference coding parameters from the variable length decoding unit 31, the inverse quantization/inverse transformation unit 32 refers to the quantization parameter and the orthogonal transformation block partitioning information which are included in the prediction difference coding parameters and inverse-quantizes the compressed data about each orthogonal transformation block according to the same procedure as that of the inverse quantization/inverse transformation unit 8 shown in FIG. 1.

At this time, the inverse quantization/inverse transformation unit refers to each header information variable-length-decoded by the variable length decoding unit 31, and, when this header information shows that the inverse quantization process is performed on the slice currently being processed by using the quantization matrix, performs the inverse quantization process by using the quantization matrix.

At this time, the inverse quantization/inverse transformation unit refers to each header information variable-length-decoded by the variable length decoding unit 31 to specify the quantization matrix to be used for each of the chrominance signals and for each coding mode (intra coding or inter coding) at each orthogonal transformation size.

The inverse quantization/inverse transformation unit 32 also performs an inverse orthogonal transformation process on the transform coefficients of each orthogonal transformation block which are the compressed data which the inverse quantization/inverse transformation unit inverse-quantizes, to calculate a decoded prediction difference signal which is the same as the local decoded prediction difference signal outputted from the inverse quantization/inverse transformation unit 8 shown in FIG. 1 (step ST28).

The adding unit 36 adds the decoded prediction difference signal calculated by the inverse quantization/inverse transformation unit 32 and either the intra prediction image P_{INTRAi}ⁿ generated by the intra prediction unit 34 or the inter prediction image P_{INTERi}ⁿ generated by the motion compensation unit 35 to calculate a decoded image and output the decoded image to the loop filter unit 38, and also stores the decoded image in the memory 37 for intra prediction (step ST29).

This decoded image is a decoded image signal which is used at the time of subsequent intra prediction processes.

When completing the processes of steps ST23 to ST29 on all the decoding blocks Bⁿ (step ST30), the loop filter unit 38 performs a predetermined filtering process on the decoded image outputted from the adding unit 36, and stores the decoded image filtering-processed thereby in the motion-compensated prediction frame memory 39 (step ST31).

Concretely, the loop filter unit performs a filtering (deblocking filtering) process of reducing a distortion occurring at a boundary between orthogonal transformation blocks and a distortion occurring at a boundary between prediction blocks, a process (pixel adaptive offset process) of adaptively adding an offset on a per pixel basis, an adaptive filtering process of performing a filtering process by adaptively switching among linear filters, such as Wiener filters, and so on.

However, for each of the above-mentioned filtering processes including the deblocking filtering process, the pixel adaptive offset process, and the adaptive filtering process, the loop filter unit 38 refers to each header information variable-length-decoded by the variable length decoding unit 31 to specify whether or not to perform the process on the slice currently being processed.

At this time, in the case in which the loop filter unit 11 of the video encoding device is configured as shown in FIG. 11 when performing two or more filtering processes, the loop filter unit 38 is configured as shown in FIG. 12.

In the deblocking filtering process, the loop filter unit refers to the header information variable-length-decoded by the variable length decoding unit 31, and, when there exists information for changing the various parameters used for the selection of the intensity of a filter applied to a block boundary from their initial values, performs the deblocking filtering process on the basis of the change information. When no change information exists, the loop filter unit performs the deblocking filtering process according to a predetermined method.

In the pixel adaptive offset process, the loop filter unit partitions the decoded image into blocks on the basis of the block partitioning information for the pixel adaptive offset process, which is variable-length-decoded by the variable length decoding unit 31, refers to the index variable-length-decoded by the variable length decoding unit 31 and indicating the class classifying method of each of the blocks on a per block basis, and, when the index does not indicate “does not perform the offset process”, performs a class classification on each pixel in each of the blocks according to the class classifying method indicated by the above-mentioned index.

As candidates for the class classifying method, the same candidates as those for the class classifying method of the pixel adaptive offset process performed by the loop filter unit 11 are prepared in advance.

The loop filter unit 38 then refers to the offset information specifying the offset value calculated for each class on a per block basis and variable-length-decoded by the variable length decoding unit 31, and performs a process of adding the offset to the brightness value of the decoded image.

In the adaptive filtering process, after performing a class classification according to the same method as that of the video encoding device of FIG. 1, the loop filter unit performs the filtering process by using the filter for each class, which is variable-length-decoded by the variable length decoding unit 31, on the basis of information about the class classification.

The decoded image on which the filtering process is performed by this loop filter unit 38 is provided as a reference image for motion-compensated prediction, and is determined as a reproduced image.

As can be seen from the above description, the video encoding device in accordance with this Embodiment 1 is configured in such a way as to, when the flag showing that the input video signal is encoded on a per field basis is valid, independently perform the mechanism of causing the intra prediction unit 4 not to perform a filtering process on the upper edge of each prediction block at the time of performing an intra prediction process according to a mean value prediction or a horizontal prediction, and the mechanism for the transformation/quantization unit 7 to change the order of encoding the transform coefficients, or perform the mechanisms in combination, there is provided an advantage of being able to implement an efficient prediction process and an efficient encoding process according to the characteristics of the field signal, and improve the coding efficiency.

Further, the video decoding device in accordance with this Embodiment 1 is configured in such a way as to, when the flag showing that the input video signal decoded by the variable length decoding unit 31 is encoded on a per field basis is valid, independently perform the mechanism of causing the intra prediction unit 34 not to perform a filtering process on the upper edge of each prediction block at the time of performing an intra prediction process according to a mean value prediction or a horizontal prediction, and the mechanism for the inverse quantization/inverse transformation unit 32 to change the order of decoding the transform coefficients, or perform the mechanisms in combination, there is provided an advantage of being able to implement an efficient prediction process and an efficient encoding process according to the characteristics of the field signal, and correctly decode a bitstream encoded by the video encoding device in accordance with Embodiment 1 which can improve the coding efficiency.

### INDUSTRIAL APPLICABILITY

As mentioned above, the video encoding device, the video decoding device, the video encoding method, and the video decoding method in accordance with the present invention are useful for a video encoding device that performs encoding with a high degree of coding efficiency, a video decoding device that performs decoding with a high degree of coding efficiency, and so on.

### EXPLANATIONS OF REFERENCE NUMERALS

1 block partitioning unit (block partitioner), 2 encoding controlling unit (encoding controller), 3 select switch, 4 intra prediction unit (predictor), 5 motion-compensated prediction unit (predictor), 6 subtracting unit (difference image generator), 7 transformation/quantization unit (image compressor), 8 inverse quantization/inverse transformation unit (local decoded image generator), 9 adding unit (local decoded image generator), 10 memory for intra prediction (predictor), 11 loop filter unit (filter), 12 motion-compensated prediction frame memory (predictor), 13 variable length encoding unit (variable length encoder), 14 slice dividing unit (slice partitioner), 31 variable length decoding unit (variable length decoder), 32 inverse quantization/inverse transformation unit (difference image generator), 33 select switch, 34 intra prediction unit (predictor), 35 motion compensation unit (predictor), 36 adding unit (decoded image generator), 37 memory for intra prediction (predictor), 38 loop filter unit (filter), 39 motion-compensated prediction frame memory (predictor), 101 block partitioning unit, 102 predicting unit, 103 compressing unit, 104 local decoding unit, 105 adder, 106 loop filter, 107 memory, 108 variable length encoding unit.

1. A video encoding device comprising:
an intra predictor that, when an intra coding mode is selected as a coding mode corresponding to a coding block, performs an intra-frame prediction process corresponding to an intra prediction parameter on each prediction block which is a unit for prediction process, which is shown by said intra coding mode, at a time of performing a prediction process on the coding block, said intra prediction parameter being used for said prediction block, to generate a prediction image, wherein
when a flag based on information showing whether or not field encoding is performed is valid, in case of a horizontal prediction, said intra predictor does not perform a filtering process on the prediction block at a time of performing an intra prediction process according to the horizontal prediction, but in case of a mean value prediction, performs a filtering process only on a left edge of the prediction block at a time of performing an intra prediction process according to the mean value prediction.

2. The video encoding device according to claim 1, wherein said video encoding device includes: a slice partitioner that partitions an inputted image into slices which are a plurality of part images; an encoding controller that determines a largest size of a coding block which is a unit to be processed at a time when an encoding process is performed, and also determines an upper limit on a number of hierarchical layers at a time when a coding block having the largest size is hierarchically partitioned, and that selects a coding mode corresponding to each of coding blocks partitioned hierarchically from one or more available coding modes; a block partitioner that partitions a slice which is partitioned by said slice partitioner into coding blocks each having the largest size determined by said encoding controller, and that also partitions each of said coding blocks hierarchically into blocks until its number of hierarchical layers reaches the upper limit determined by said encoding controller; a difference image generator that generates a difference image between the coding block partitioned by said block partitioner and the prediction image generated by said intra predictor; an image compressor that performs a transformation process on the difference image generated by said difference image generator and quantizes transform coefficients of said difference image, and that outputs the transform coefficients quantized thereby as compressed data; a local decoded image generator that decodes the difference image from the compressed data outputted from said image compressor, and that adds the difference image decoded and the prediction image generated by said predictor to generate a local decoded image; and a variable length encoder that generates an encoded bitstream, wherein
said variable length encoder variable-length-encodes the compressed data outputted from said image compressor, the coding mode selected by said encoding controller, and the flag showing whether or not the field encoding is performed, and generates an encoded bitstream into which coded data of said compressed data, coded data of said coding mode, and coded data of said flag are multiplexed.

3. A video decoding device comprising:
an intra predictor that, when a coding mode variable-length-decoded and associated with a coding block is an intra coding mode, performs an intra-frame prediction process corresponding to an intra prediction parameter on each prediction block which is a unit for prediction process, which is shown by said intra coding mode, at a time of performing a prediction process on the coding block, said intra prediction parameter being used for said prediction block, to generate a prediction image, wherein
when a flag based on information showing whether or not field encoding is performed is valid, in case of a horizontal prediction, said intra predictor does not perform a filtering process on the prediction block at a time of performing an intra prediction process according to the horizontal prediction, but in case of a mean value prediction, performs a filtering process only on a left edge of the prediction block at a time of performing an intra prediction process according to the mean value prediction.

4. The video decoding device according to claim 3, wherein said video decoding device includes: a variable length decoder that variable-length-decodes header information including the flag showing whether or not the field encoding is performed from encoded data multiplexed into an encoded bitstream, and that variable-length-decodes compressed data and a coding mode associated with each of hierarchically partitioned coding blocks from said encoded data; a predictor that performs a prediction process according to the coding mode variable-length-decoded by said variable length decoder and associated with the coding block, to generate a prediction image; a difference image generator that inverse-quantizes transform coefficients which are the compressed data variable-length-decoded by said variable length decoder and associated with the coding block and inverse-transforms the inverse-quantized transform coefficients, to generate a difference image before compression; and a decoded image generator that adds the difference image generated by said difference image generator and the prediction image generated by said predictor to generate a decoded image.

5. A video encoding method comprising:
an intra prediction step of, when an intra coding mode is selected as a coding mode corresponding to a coding block, performing an intra-frame prediction process corresponding to an intra prediction parameter on each prediction block which is a unit for prediction process, which is shown by said intra coding mode, at a time of performing a prediction process on the coding block, said intra prediction parameter being used for said prediction block, to generate a prediction image, wherein
in said intra prediction step, when a flag based on information showing whether or not field encoding is performed is valid, in case of a horizontal prediction, a filtering process on the prediction block at a time of performing an intra prediction process according to the horizontal prediction is not performed, but in case of a mean value prediction, a filtering process only on a left edge of the prediction block at a time of performing an intra prediction process according to the mean value prediction is performed.

6. A video decoding method comprising:
an intra prediction step of, when a coding mode variable-length-decoded and associated with a coding block is an intra coding mode, performing an intra-frame prediction process corresponding to an intra prediction parameter on each prediction block which is a unit for prediction process, which is shown by said intra coding mode, at a time of performing a prediction process on the coding block, said intra prediction parameter being used for said prediction block, to generate a prediction image, wherein
in said intra prediction step, when a flag based on information showing whether or not field encoding is performed is valid, in case of a horizontal prediction, a filtering process on the prediction block at a time of performing an intra prediction process according to the horizontal prediction is not performed, but in case of a mean value prediction, a filtering process only on a left edge of the prediction block at a time of performing an intra prediction process according to the mean value prediction is performed.
